(19) United States
(12) Patent Application Publication
(10) Pub. No.: US 2024/0279488 A1
(43) Pub. Date: Aug. 22, 2024

(54) MULTILAYER BODY FOR DISPLAY DEVICES, AND DISPLAY DEVICE, STACKED BODY FOR DISPLAY DEVICE AND DISPLAY DEVICE

(71) Applicant: DAI NIPPON PRINTING CO., LTD., Tokyo (JP)

(72) Inventors: Saori KAWAGUCHI, Tokyo (JP); Keisuke YAMADA, Tokyo (JP); Jun SATO, Tokyo (JP)

(21) Appl. No.: 18/559,743

(22) PCT Filed: May 12, 2022
(86) PCT No.: PCT/JP2022/020016

§ 371 Date: Apr. 12, 2024

(30) Foreign Application Priority Data
May 13, 2021 (JP) 2021-081469

(51) Int. Cl. C09D 5/24; C09D 5/00; C09D 7/65; C09D 133/14

(52) U.S. Cl. CPC C09D 5/24; C09D 5/002; C09D 7/65; C09D 133/14

(57) ABSTRACT

The present disclosure provides a stacked body for a display device comprising a substrate layer and a functional layer including fluorine, wherein an absolute value of a charge amount on a functional layer side surface of the stacked body for a display device after an eraser test is 10.0 nC or less, wherein, in the eraser test, the functional layer side surface of the stacked body for a display device is rubbed with a 6 mm diameter eraser, for 2500 strokes, applying a load of 9.8 N.

### TECHNICAL FIELD

The present disclosure relates to a stacked body for a display device, and a display device using the same.

### BACKGROUND ART

For example, a stacked body provided with a functional layer having various properties such as a hard coating property, a scuff resistance, antireflection property, an antiglare property, an antistatic property, and an antifouling property, is placed on the surface of a display device.

In recent years, not only smart phones and tablet terminals but also display devices such as notebook type personal computers have a touch function. In a display device having a touch function, abrasion resistance and sliding property are required since they are operated by directly touching the surface thereof with a finger and so on.

Further, portable display devices such as smart phones and tablet terminals may be stored in, for example, pockets of clothing or a bag so that the surface of the display devices may be rubbed by the cloth of the clothing or a bag, or by other items stored in the pockets of clothing or a bag. For this reason, further abrasion resistance is required for the portable display devices.

In recent years, flexible displays such as a foldable display, a rollable display, and a bendable display have been attracting attention, and a stacked body placed on the surface of the flexible display has been actively developed. For example, a use of a resin substrate instead of a glass substrate has been studied, and for example, Patent Document 1 proposes a display device window film comprising a plastic substrate having high hardness and excellent optical properties, and a hard coating layer placed on at least one surface of the plastic substrate.

Since flexible displays are used or stored in a bent condition, for example, the surface of the bent portion is likely to be rubbed. Therefore, in the flexible display, further superior abrasion resistance is required in the bent portion.

Examples of a known approach to increase the abrasion resistance may include a decrease of a friction coefficient. Specifically, a technique of imparting low friction property by applying a fluorine based surface treatment agent or by adding a fluorine based additive is known. For example, Patent Document 2 discloses a surface treatment agent including a fluorooxyalkylene group-containing polymer composition capable of providing a coating excellent in water repellency-oil repellency, scuff resistance, low dynamic friction property, and abrasion resistance.

However, since the surface of the functional layer in the stacked body is rubbed, the component included in the functional layer may be rubbed away, or the functional layer may be worn down, so that the performance of the functional layer may be deteriorated. Therefore, further improvement in abrasion resistance is desired.

### CITATION LIST

### Patent Documents

Patent Document 1: Japanese Patent Application Laid-Open (JP-A) No. 2016-125063
Patent Document 2: Japanese Patent No. 6140348

### SUMMARY OF DISCLOSURE

### Technical Problem

The present disclosure has been made in view of the above circumstances, and an object of the present disclosure is to provide a stacked body for a display device and a display device with good abrasion resistance.

### Solution to Problem

In order to solve the above problem, the inventors of the present disclosure have focused on an eraser test as an abrasion test, and as a result of intensive studies about the abrasion resistance of the stacked body for a display device, they surprisingly and newly found out a correlation between the abrasion resistance and the absolute value of a charge amount. The present disclosure is based on these findings.

One embodiment of the present disclosure provides a stacked body for a display device comprising a substrate layer and a functional layer including fluorine, wherein an absolute value of a charge amount on a functional layer side surface of the stacked body for a display device after an eraser test is 10.0 nC or less, wherein, in the eraser test, the functional layer side surface of the stacked body for a display device is rubbed with a 6 mm diameter eraser, for 2500 strokes, applying a load of 9.8 N.

In the stacked body for a display device in the present disclosure, a ratio of a maximum value of a frictional force to the eraser after the eraser test with respect to an average value of a frictional force to the eraser before the eraser test, on the functional layer side surface of the stacked body for a display device before the eraser test, is preferably 1.7 or less.

Also, in the stacked body for a display device in the present disclosure, a ratio of a proportion of number of fluorine atoms with respect to a total number of atoms of all elements on the functional layer side surface after the eraser test; with respect to a proportion of number of fluorine atoms with respect to a total number of atoms of all elements on the functional layer side surface before the eraser test, measured by an X-ray photoelectron spectroscopy method, is preferably 0.4 or more.

Also, in the stacked body for a display device in the present disclosure, the functional layer preferably includes an antistatic agent. In this case, the antistatic agent is preferably a conductive polymer.

Also, in the stacked body for a display device in the present disclosure, an impact absorbing layer may be included on the substrate layer, on an opposite surface side to the functional layer, or between the substrate layer and the functional layer.

Also, in the stacked body for a display device in the present disclosure, an adhesive layer for adhesion may be included on the substrate layer, on an opposite surface side to the functional layer.

Another embodiment of the present disclosure provides a display device comprising: a display panel, and the stacked body for a display device described above placed on an observer side of the display panel.

### Advantageous Effects of Disclosure

The present disclosure has an effect that a stacked body for a display device and a display device with good abrasion resistance may be provided.

### BRIEF DESCRIPTION OF DRAWINGS

FIG. 1 is a schematic cross-sectional view illustrating an example of a stacked body for a display device in the present disclosure.

FIG. 2 is a schematic diagram explaining a method for measuring a frictional force with respect to an eraser.

FIGS. 3A to 3C are schematic views explaining a dynamic bending test.

FIG. 4 is a schematic cross-sectional view illustrating an example of a stacked body for a display device in the present disclosure.

FIG. 5 is a schematic cross-sectional view illustrating an example of a stacked body for a display device in the present disclosure.

FIG. 6 is a schematic cross-sectional view illustrating an example of a stacked body for a display device in the present disclosure.

FIG. 7 is a schematic cross-sectional view illustrating an example of a display device in the present disclosure.

### DESCRIPTION OF EMBODIMENTS

Embodiments in the present disclosure are hereinafter explained with reference to, for example, drawings. However, the present disclosure is enforceable in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure. Also, in the present description and each drawing, for the factor same as that described in the figure already explained, the same reference sign is indicated and the detailed explanation thereof may be omitted.

In the present descriptions, in expressing an aspect wherein some member is placed on the other member, when described as merely “on” or “below”, unless otherwise stated, it includes both of the following cases: a case wherein some member is placed directly on or directly below the other member so as to be in contact with the other member, and a case wherein some member is placed on the upper side or the lower side of the other member via yet another member. Also, in the present descriptions, on the occasion of expressing an aspect wherein some member is placed on the surface of the other member, when described as merely “on the surface side” or “on the surface”, unless otherwise stated, it includes both of the following cases: a case wherein some member is placed directly on or directly below the other member so as to be in contact with the other member, and a case wherein some member is placed on the upper side or the lower side of the other member via yet another member.

The inventors of the present disclosure have focused on an eraser test as an abrasion test, and as the result of intensive studies about the abrasion resistance of the stacked body for a display device, they have gained the following knowledges.

The inventors of the present disclosure carried out an eraser test on a stacked body for a display device and measured the frictional force before and after the eraser test and the charge amount after the eraser test, and they have found out that, when the absolute value of a charge amount after the eraser test is relatively low, the change in frictional force before and after the eraser test tends to be relatively low. In other words, it was found out that there was a correlation between the abrasion resistance and the absolute value of a charge amount after the eraser test. Further, the correlation between the abrasion resistance and the absolute value of a charge amount after the eraser test was investigated in detail, and it was found that, in order to impart excellent abrasion resistance, it is important to set the absolute value of a charge amount after the eraser test at a predetermined value or less.

A stacked body for a display device and a display device in the present disclosure are hereinafter described in detail.

### A. Stacked Body for Display Device

The stacked body for a display device in the present disclosure comprises a substrate layer and a functional layer including fluorine, wherein an absolute value of a charge amount on a functional layer side surface of the stacked body for a display device after an eraser test is 10.0 nC or less, wherein, in the eraser test, the functional layer side surface of the stacked body for a display device is rubbed with a 6 mm diameter eraser, for 2500 strokes, applying a load of 9.8 N.

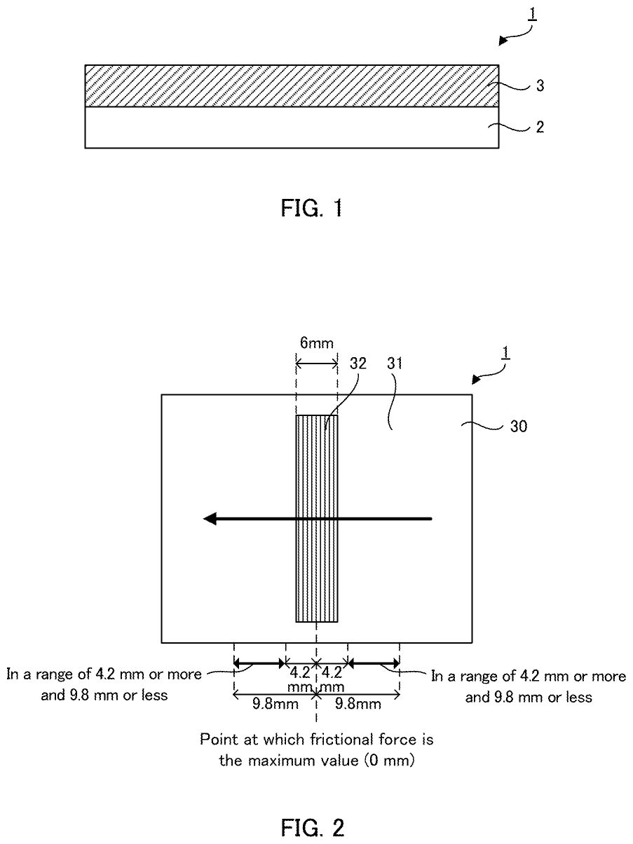

FIG. 1 is a schematic cross-sectional view illustrating an example of a stacked body for a display device in the present disclosure. As shown in FIG. 1, the stacked body for a display device 1 comprises a substrate layer 2, and a functional layer 3. Also, the absolute value of a charge amount on the functional layer 3 side surface of the stacked body for a display device 1 after a predetermined eraser test is a predetermined value or less.

As described above, the present disclosure is based on a new finding in the stacked body for a display device that there is a correlation between the abrasion resistance and the absolute value of a charge amount after the eraser test. In the present disclosure, since the absolute value of a charge amount on the functional layer side surface of the stacked body for a display device after the eraser test is a predetermined value or less, good abrasion resistance may be obtained.

Although the reason therefore is not clear, it is presumed as follows. In other words, when an eraser test is carried out on the surface of the stacked body for a display device, the surface of the stacked body for a display device is charged by friction due to the eraser. In general, the surface of a layer including fluorine tends to be negatively charged, so that the functional layer including fluorine tends to be negatively charged, and the functional layer side surface of the stacked body for a display device is negatively charged by friction due to the eraser. Due to this effect, the contact surface of the eraser, to the functional layer side surface of the stacked body for a display device, is positively charged. In this case, when the electrostatic force increases by carrying out the eraser test, that is, when the absolute value of a charge amount after the eraser test is large, the attracting force increases, so that it is believed that the fluorine included in the functional layer is desorbed and it is easily adhered to the eraser. When the fluorine included in the functional layer is desorbed, the abrasion resistance effect due to the fluorine is reduced. Meanwhile, when the static electricity force is small even after the eraser test, that is, when the absolute value of a charge amount after the eraser test is small, the attracting force is small, so that the fluorine included in the functional layer is considered to be difficult to be desorbed. In this case, the abrasion resistance effect due to the fluorine may be maintained. Therefore, in the present disclosure, since the absolute value of a charge amount on the functional layer side surface of the stacked body for a display device after the eraser test is a predetermined value or less, it is believed that the functional layer side surface of the stacked body for a display device may be suppressed from being charged by the eraser test, so that the desorption of the fluorine due to the eraser test described above may be suppressed.

As the result, it is estimated that good abrasion resistance may be obtained.

Also, rubbing with an eraser is similar to rubbing with a stylus pen, and by the eraser test, for example, abrasion resistance against relatively soft objects such as stylus pens, fingers, clothing and bag fabrics may be evaluated. In the present disclosure, since the absolute value of a charge amount on the functional layer side surface of the stacked body for a display device after the eraser test is a predetermined value or less, good abrasion resistance against relatively soft objects such as stylus pens, fingers, clothing and bag fabrics, may be obtained.

Each constitution of the stacked body for a display device in the present disclosure is hereinafter described.

### 1. Properties of Stacked Body for Display Device

In the present disclosure, an absolute value of a charge amount on a functional layer side surface of the stacked body for a display device after an eraser test is 10.0 nC or less, preferably 8 nC or less, and more preferably 6 nC of less, wherein, in the eraser test, the functional layer side surface of the stacked body for a display device is rubbed with a 6 mm diameter eraser, for 2500 strokes, applying a load of 9.8 N. When the absolute value of a charge amount is in the above range, good abrasion resistance may be obtained. Also, the lower the absolute value of a charge amount, the better, and for example, it may be 0 nC.

Here, the eraser test may be carried out by the following method. That is, using a 6 mm diameter eraser, the eraser is inserted into a jig provided with a 6 mm diameter hole so that 4 mm of the tip of the eraser is exposed from the jig, the jig with the eraser is installed into a color fastness rubbing tester, and the functional layer side surface of the stacked body for a display device is rubbed with the eraser for 2500 strokes, under conditions of applied load of 9.8 N, at traveling speed of 80 mm/sec, and traveling distance of 40 mm. As the 6 mm diameter eraser, for example, $6 mm eraser from Minoan Co., Ltd. may be used. Also, as a color fastness rubbing tester, for example, Color Fastness Rubbing Tester AB-301 from Tester Sangyo Co., Ltd. may be used.

Also, the charge amount may be measured by the following method. Firstly, using a glass plate as a test stand, the ionizer was applied to the glass plate for one minute to eliminate static. Also, a test piece is prepared by cutting the stacked body for a display device into a size of 20 mm×80 mm (including an eraser tested portion of 6 mm×40 mm), and an ionizer is applied to both surfaces of the test piece for 30 seconds or more and 60 seconds or less to eliminate static.

Then, the end portion of the test piece is fixed on the glass plate with cellophane tape, and the eraser test is carried out. Then, the test piece after the eraser test is set on a Faraday gauge and the charge amount is measured under conditions of temperature of 23±5° C. and humidity of 40±10% RH.

In doing so, insulating and non-magnetic tweezers are used to pinch the eraser test-untested portion (the end portion of the sample), and lift the test piece after the eraser test. Also, after lifting the test piece after the eraser test, the charge amount is measured without contacting to other fixed surfaces. The charge amount is measured within 3 minutes after the eraser test. Also, the measurement point of the charge amount is allover the sample size.

As the Faraday gauge, for example, a Faraday gauge “KQ-1400” from Kasuga Denki Inc. may be used. Also, for example, “KD-750B” fan-type ionizer from Kasuga Denki Inc. may be used as the ionizer. Also, for example, ESD (electrostatic countermeasure) tweezers “P-643-S” from Kenis Limited may be used as tweezers.

Examples of the method for adjusting the absolute value of a charge amount on the functional layer side surface of the stacked body for a display device after the eraser test may include a method wherein the surface hardness of the functional layer is adjusted; a method wherein the thickness of the functional layer is adjusted; a method wherein the fluorine concentration on the functional layer side surface of the stacked body for a display device is adjusted; a method wherein the content of an antistatic agent is adjusted; a method wherein the position of layer including an antistatic agent is adjusted; and a method wherein the drying temperature during the formation of the functional layer is adjusted.

For example, when the surface hardness of the functional layer increases, the absolute value of a charge amount tends to decrease. Also, for example, when the thickness of the functional layer decreases, the surface hardness of the functional layer decreases so that the absolute value of a charge amount tends to increase; meanwhile, when the thickness of the functional layer increases, the surface hardness of the functional layer increases so that the absolute value of a charge amount tends to decrease. Also, for example, when the fluorine concentration on the functional layer side surface of the stacked body for a display device increases, the sliding property improves so that the absolute value of a charge amount tends to decrease; meanwhile, when the fluorine concentration on the functional layer side surface of the stacked body for a display device decreases, the sliding property decreases so that the absolute value of a charge amount tends to increase.

Also, for example, although the absolute value of a charge amount tends to decrease when the content of the antistatic agent increases, when the content of the antistatic agent increases too much, the surface hardness of the functional layer decreases so that the absolute value of a charge amount tends to increase; meanwhile, when the content of the antistatic agent decreases, the surface hardness of the functional layer increases so that the absolute value of a charge amount tends to decrease.

Also, for example, when the distance between the surface on which the eraser test is carried out and the layer including the antistatic agent decreases, the absolute value of a charge amount tends to decrease; meanwhile, when the distance between the surface on which the eraser test is carried out and the layer including the antistatic agent increases, the absolute value of a charge amount tends to increase.

In the present disclosure, the distance between the surface on which the eraser test is carried out and the layer including the antistatic agent is preferably 10 μm or less, particularly preferably 6 μm or less, and among the above, preferably 4 μm or less.

Here, “distance between the surface on which the eraser test is carried out and the layer including the antistatic agent” refers to the following distance.

That is, “the surface on which the eraser test is carried out” is the functional layer side outermost surface of the stacked body for a display device. Also, “the layer including the antistatic agent” refers to the first layer including the antistatic agent, when viewed from the outermost surface side to the substrate layer side. That is, when the outermost surface layer includes the antistatic agent, the outermost surface layer is the layer including the antistatic agent; and when the outermost surface layer does not include the antistatic agent, and the antistatic agent is included in the next layer, the next layer is “the layer including the antistatic agent”.

The “distance between the surface on which the eraser test is carried out and the layer including the antistatic agent” refers to the distance from the outermost surface to the outermost surface side surface of “the layer including the antistatic agent”.

Also, for example, the absolute value of a charge amount tends to decrease when the drying temperature during the formation of the functional layer decreases. Meanwhile, as the drying temperature during the formation of the functional layer increases, the antistatic agent is hardly migrated to the functional layer surface so that the absolute value of a charge amount tends to increase.

Also, in the present disclosure, the maximum load at which a bruise is not recognized on the functional layer side surface of the stacked body for a display device, when a steel wool test is carried out is preferably, for example, 4.9 N or more, more preferably 9.8 N or more, and further preferably 14.7 N or more, wherein, in the steel wool test, the functional layer side surface of the stacked body for a display device is rubbed with a #0000 steel wool, for 2500 strokes, applying a predetermined load. When the maximum load is in the above range, the hardness of the functional layer side surface of the stacked body for a display device may be increased so that the scuff resistance may be improved.

Here, the steel wool test may be carried out by the following method. That is, using #0000 steel wool, the steel wool is fixed to a 2 cm×2 cm jig, and the functional layer side surface of the stacked body for a display device is rubbed for 2500 strokes under conditions of reciprocating speed of 40 rpm and reciprocating distance of 40 mm. As the #0000 steel wool, Bonstar #0000 from Nippon Steel Wool Co., Ltd. may be used. Also, as a tester, for example, Color Fastness Rubbing Tester AB-301 from Tester Sangyo Co., Ltd. may be used. Incidentally, for the steel wool test, for example, a protection film including an adhesive layer on one surface of the PET substrate is adhered to the substrate layer side surface of a stacked body for a display device with a size of 4 cm×10 cm, and then, and the test is carried out in a state where the stacked body for a display device is placed on a testing device so that the functional layer side surface is on the front, and the end portion of the stacked body for a display device is fixed with cellophane tape.

Incidentally, for example, the abrasion resistance with respect to relatively hard matter such as an item stored in the pockets of clothing or a bag may be evaluated by the steel wool test.

Also, in the present disclosure, the pencil hardness of the functional layer side surface of the stacked body for a display device is preferably, for example, H or more, more preferably 2H or more, and further preferably 3H or more. When the pencil hardness is in the above range, the hardness of the functional layer side surface of the stacked body for a display device may be increased so that the scuff resistance may be improved.

Here, the pencil hardness is measured by the pencil hardness test specified by JIS K5600-5-4 (1999). Specifically, using a pencil for the test specified by JIS-S-6006, the pencil hardness test specified by JIS K5600-5-4 (1999) is carried out to the functional layer side surface of the stacked body for a display device, and the pencil hardness may be determined by evaluating the highest pencil hardness at which the sample is not bruised. The measurement conditions may be angle of 45°, load of 1000 g, testing rate of 0.5 mm/sec or more and 1 mm/sec or less, and temperature of 23±2° C. As the pencil hardness tester, for example, a pencil scratch hardness tester from Toyo Seiki Seisaku-sho, Ltd. may be used.

Also, in the present disclosure, the average value of a frictional force to the eraser on the functional layer side surface of the stacked body for a display device is preferably, for example, 0.98 N or more and 9.80 N or less, more preferably 1.96 N or more and 8.80 N or less, and further preferably 2.45 N or more and 7.80 N or less. When the average value of the frictional force to the eraser before the eraser test is in the above range, the abrasion resistance may be improved.

Also, in the present disclosure, the maximum value of a frictional force to the eraser on the functional layer side surface of the stacked body for a display device after an eraser test is preferably, for example, 0.98 N or more and 9.80 N or less, more preferably 1.96 N or more and 8.80 N or less, and further preferably 2.45 or more and 7.80 N or less wherein, in the eraser test, the functional layer side surface of the stacked body for a display device is rubbed with a 6 mm diameter eraser, for 2500 strokes, applying a load of 9.8 N. When the frictional force to the eraser after the eraser test is in the above range, good abrasion resistance may be obtained, as well as good antistatic property may be maintained.

Also, the ratio of the maximum value of the frictional force to the eraser after the eraser test with respect to the average value of a frictional force to the eraser before the eraser test, on the functional layer side surface of the stacked body for a display device, is preferably, for example, 1.7 or less, more preferably 1.5 or less, and further preferably 1.3 or less. When the ratio of the frictional force to the eraser is in the above range, the abrasion resistance may be improved. Also, the lower the ratio of the frictional force to the eraser, the better, and for example, it may be 1.00.

The ratio of the frictional force to the eraser may be determined from the following formula, when the average value of the frictional force to the eraser before the eraser test, on the functional layer side surface of the stacked body for a display device before the eraser test is regarded as “A”; and the maximum value of a frictional force to the eraser after the eraser test, on the functional layer side surface of the stacked body for a display device, is regarded as “B”.

Ratio of frictional force=B/A

Here, the frictional force to the eraser may be measured by, using a 6 mm diameter eraser, inserting the eraser into a jig provided with a 6 mm diameter hole so that 4 mm of the tip of the eraser is exposed from the jig, installing the jig with the eraser into a friction measurement device, and rubbing the functional layer side surface of the stacked body for a display device with the eraser, under conditions of applied load of 1.96 N, at traveling speed of 840 mm/min. As the 6 mm diameter eraser, for example, $6 mm eraser from Minoan Co., Ltd. may be used. Also, as a friction measurement device, for example, TriboGear Type 18 from Shinto Scientific Co., Ltd. may be used. Specifically, as shown in FIG. 2, the eraser test described above is firstly carried out to a part of functional layer side surface 30 of the stacked body for a display device 1, and eraser tested portion 32 having a rectangular shape is formed. Then, using the eraser, the functional layer side surface 30 of the stacked body for a display device 1 is rubbed, as shown with an arrow, in the order of eraser test-untested portion 31, eraser tested portion 32, and eraser test-untested portion 31 to measure the frictional force. In doing so, as shown with the arrow, the eraser is moved vertical to the longitudinal direction of the rectangle eraser tested portion 32. The average value of the frictional force to the eraser of the eraser test-untested portion may be regarded as the average value of the frictional force to the eraser before the eraser test, and the maximum value of the frictional force to the eraser of the eraser tested portion may be regarded as the maximum value of the friction force to the eraser after the eraser test. Also, as shown in FIG. 2, the average value of the frictional force to the eraser before the eraser test is regarded as, when the point at which the frictional force to the eraser of the eraser tested portion 32 is the maximum is regarded as 0 mm, the average value of the frictional force in the eraser test-untested portion 31, in a range of 4.2 mm or more and 9.8 mm or less, on the basis of the point (0 mm) described above.

Also, in the present disclosure, the proportion of number of fluorine atoms with respect to a total number of atoms of all elements on the functional layer side surface of the stacked body for a display device, measured by an X-ray photoelectron spectroscopy method, is preferably, for example, 7 at % or more and 60 at % or less, more preferably 20 at % or more and 50 at % or less, and further preferably 25 at % or more and 45 at % or less. When the proportion of number of fluorine atoms before the eraser test is in the above range, the abrasion resistance may be improved.

Also, in the present disclosure, the proportion of number of fluorine atoms with respect to a total number of atoms of all elements on the functional layer side surface of the stacked body for a display device, measured by an X-ray photoelectron spectroscopy method, after an eraser test, is preferably, for example, 7 at % or more and 60 at % or less, more preferably 20 at % or more and 50 at % or less, and further preferably 25 at % or more and 45 at % or less wherein, in the eraser test, the functional layer side surface of the stacked body for a display device is rubbed with a 6 mm diameter eraser, for 2500 strokes, applying a load of 9.8 N. When the proportion of number of fluorine atoms after the eraser test is in the above range, the desorption of fluorine atom included in the functional layer, due to the eraser test, may be suppressed so that the abrasion resistance may be improved.

Also, the ratio of a proportion of number of fluorine atoms with respect to a total number of atoms of all elements on the functional layer side surface of the stacked body for a display device after the eraser test; with respect to a proportion of number of fluorine atoms with respect to a total number of atoms of all elements on the functional layer side surface of the stacked body for a display device before the eraser test, measured by an X-ray photoelectron spectroscopy method, is preferably, for example, 0.4 or more, more preferably 0.6 or more, and further preferably 0.7 or more. When the ratio of a proportion of number of fluorine atoms is in the above range, the abrasion resistance may be improved. Also, the higher the ratio of a proportion of number of fluorine atoms, the better, and for example, it may be 1.0.

The ratio of a proportion of number of fluorine atoms may be determined from the following formula, when the proportion of number of fluorine atoms with respect to a total number of atoms of all elements on the functional layer side surface of the stacked body for a display device before the eraser test is regarded as “C”; and the proportion of number of fluorine atoms with respect to a total number of atoms of all elements on the functional layer side surface of the stacked body for a display device after the eraser test is regarded as “D”.

Ratio of the proportion of the number of fluorine atoms=D/C.

Also, in the present disclosure, the proportion of number of fluorine atoms with respect to a total number of atoms of all elements on the eraser surface, measured by an X-ray photoelectron spectroscopy method, is preferably, for example, detection limit or less.

Also, in the present disclosure, the proportion of number of fluorine atoms with respect to a total number of atoms of all elements on the contact surface of the eraser, with the functional layer side surface of the stacked body for a display device, measured by an X-ray photoelectron spectroscopy method, after an eraser test, is preferably, for example, 15 at % or less, more preferably 10 at % or less, and further preferably 5 at % or less wherein, in the eraser test, the functional layer side surface of the stacked body for a display device is rubbed with a 6 mm diameter eraser, for 2500 strokes, applying a load of 9.8 N. When the proportion of number of fluorine atoms on the contact surface of the eraser after the eraser test is in the above range, the desorption of fluorine included in the functional layer, due to the eraser test, and adhesion to the eraser may be suppressed so that the abrasion resistance may be improved.

Here, the proportion of number of fluorine atoms with respect to the total number of atoms of all elements is the proportion of number of fluorine atoms with respect to a total number of atoms of all elements existing on the sample surface, measured by an X-ray photoelectron spectroscopy method (XPS), and specifically, it refers to the ratio of the number of atoms (at %) of fluorine atom when total number of atoms of carbon atoms, oxygen atoms, fluorine atoms, nitrogen atoms, silicon atoms, calcium atoms, and chlorine atoms is regarded as 100 at %.

The proportion of number of fluorine atoms with respect to the total number of atoms of all elements may be determined by analyzing the composition of the sample surface by an X-ray photoelectron spectroscopy (XPS). Specifically, it may be determined by the following procedure. Firstly, using an X-ray photoelectron spectrometer, X-rays are irradiated from the sample surface in the depth direction under the following conditions, and X-ray photoelectron spectrum is measured. For example, “AXIS-NOVA” from Kratos Analytical Ltd. may be used as an X-ray photoelectron spectrometer. When measuring the proportion of number of fluorine atoms with respect to a total number of atoms of all elements, the ratio of the number of atoms (at %) of fluorine atom, when total number of atoms of carbon atoms, oxygen atoms, fluorine atoms, nitrogen atoms, silicon atoms, calcium atoms, and chlorine atoms is regarded as 100 at %, may be determined from the peak area using a relative sensitivity coefficient method, by deducting the background determined by the Shirley method from the obtained spectrum, setting C, O, F, N, Si, Ca and Cl as analysis target elements.

### <Measurement Conditions>

Incident X-ray: Monochromated Al-Kα-ray (monochromated X-ray, Hv=1486.6 eV)
X-ray irradiation region (measured area): 110 μm
X-ray output: 150 W (15 kV, 6.7 mA)
Photoelectron intake angle; 90°±15° (sample normal line is regarded as 0°)
Charge neutralization conditions: electron neutralization gun (+6 V, 0.05 mA), low-acceleration Ar⁺ ion irradiation
Measured peaks: C1s, O1s, F1s, N1s, Si2p, Ca2p, Cl2p

Also, when measuring the proportion of the number of fluorine atoms with respect to the total number of atoms of all elements on the functional layer side surface of the stacked body for a display device before the eraser test and the proportion of the number fluorine atoms with respect to the total number of atoms of all elements on the functional layer side surface of the stacked body for a display device after the eraser test, for example, as described above, by forming an eraser tested portion 32 as shown in FIG. 2, the proportion of the number fluorine atoms with respect to the total number of atoms of all elements on the eraser test-untested portion 31 may be regarded as the proportion of the number of fluorine atoms with respect to the total number of atoms of all elements before the eraser test; and the proportion of the number fluorine atoms with respect to the total number of atoms of all elements on the eraser tested portion 32 may be regarded as the proportion of the number fluorine atoms with respect to the total number of atoms of all elements after the eraser test.

The total light transmittance of the stacked body for a display device in the present disclosure is preferably, for example, 85% or more, more preferably 88% or more, and further preferably 90% or more. When the total light transmittance is high as described above, the stacked body for a display device may have good transparency.

Here, the total light transmittance of the stacked body for a display device may be measured according to JIS K7361-1, and may be measure with, for example, a haze meter HM150 from Murakami Color Research Laboratory Co., Ltd.

The haze of the stacked body for a display device in the present disclosure is preferably, for example, 5% or less, more preferably 2% or less, and further preferably 1% or less. When the haze is low as described above, the stacked body for a display device may have good transparency.

Here, the haze of the stacked body for a display device may be measured according to JIS K-7136, and may be measure with, for example, a haze meter HM150 from Murakami Color Research Laboratory Co., Ltd.

The stacked body for a display device in the present disclosure preferably has a bending resistance. Specifically, when the dynamic bending test described below is carried out to the stacked body for a display device, it is preferable that a crack or a fracture does not occur in the stacked body for a display device.

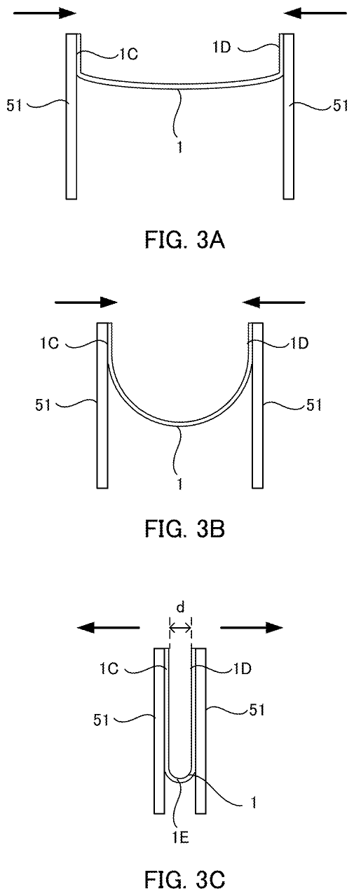

The dynamic bending test is carried out as follows. Firstly, a stacked body for a display device having a size of 20 mm×100 mm is prepared. Then, in the dynamic bending test, as shown in FIG. 3A, short side portion 1C and short side portion 1D opposing to the short side portion 1C of the stacked body for a display device 1 are respectively fixed by parallelly arranged fixing portions 51. Also, as shown in FIG. 3A, the fixing portions 51 are movable by sliding in horizontal direction. Then, as shown in FIG. 3B, by moving the fixing portions 51 so as to be closer to each other, the stacked body for a display device 1 is deformed so as to be folded. Further, as shown in FIG. 3C, after moving the fixing portions 51 to the position wherein distance “d” between the two opposing short side portions 1C and 1D of the stacked body for a display device 1 fixed by the fixing portions 51 is a predetermined value, the deformation of the stacked body for a display device 1 is dissolved by moving the fixing portions 51 in opposite directions. As shown in FIGS. 3A to 3C, by moving the fixing portions 51, the stacked body for a display device 1 may be folded into 180°. Also, by carrying out the dynamic bending test so that bent portion 1E of the stacked body for a display device 1 does not protrude from the lower end edge of the fixing portions 51, and by controlling the distance when the fixing portions 51 are the closest, distance “d” between the two opposing short side portions 1C and 1D of the stacked body for a display device 1 may be a predetermined value. For example, when the distance “d” between the short side portions 1C and 1D is 30 mm, the outer diameter of the bent portion 1E is regarded as 30 mm.

In the stacked body for a display device, it is preferable that a crack or a fracture does not occur when the dynamic bending test wherein the stacked body for a display device 1 is folded into 180° so that the distance “d” between the opposing short side portions 1C and 1D of the stacked body for a display device 1 is 30 mm, is carried out repeatedly for 200,000 times, and it is more preferable that a crack or a fracture does not occur when the dynamic bending test is carried out repeatedly for 500,000 times. Among the above, it is preferable that a crack or a fracture does not occur when the dynamic bending test wherein the stacked body for a display device 1 is folded into 1800 so that the distance “d” between the opposing short side portions 1C and 1D of the stacked body for a display device is 20 mm, is carried out repeatedly for 200,000 times; particularly, it is preferable that a crack or a fracture does not occur when the dynamic bending test wherein the stacked body for a display device 1 is folded into 1800 so that the distance “d” between the opposing short side portions 1C and 1D of the stacked body for a display device 1 is 10 mm, is carried out repeatedly for 200,000 times.

In the dynamic bending test, the stacked body for a display device may be folded so that the functional layer is on the outer side, or the stacked body for a display device may be folded so that the functional layer is on the inner side; and in either of these cases, it is preferable that a crack or a fracture does not occur in the stacked body for a display device.

### 2. Functional Layer

The functional layer in the present disclosure is a layer placed on one surface side of the substrate layer, and including fluorine. By including the fluorine, the functional layer is able to impart abrasion resistance and antifouling property to the stacked body for a display device.

The functional layer is not particularly limited as long as it includes fluorine. The functional layer may include, for example, a fluorine compound and resin, and may include fluorine resin.

When the functional layer includes a fluorine compound and resin, as the fluorine compound, for example, those knowns as a fluorine based antifoulant, a fluorine based leveling agent and a fluorine based surfactant may be used. Examples of the fluorine compound may include an organic fluorine compound, and specific examples thereof may include a perfluoro compound. Examples of the perfluoro compound may include a perfluoro compound including, for example, a perfluoro polyether group, a perfluoro alkylene group, and a perfluoro alkyl group. The perfluoro alkylene group and perfluoro alkyl group may be linear or branched. One kind of the fluorine compound may be used alone, and two kinds or more may be used as a mixture.

Also, the fluorine compound is preferably bonded to a resin component. Since the fluorine compound is bonded to the resin component, the bleed-out of the fluorine compound may be suppressed, and the abrasion resistance and antifouling property may be maintained over a long period of time. Also, the abrasion resistance and antifouling property may be easily maintained even after the eraser test.

Since the fluorine compound is preferably bonded to a resin component, a fluorine compound including a reactive functional group is preferably used. That is, the functional layer preferably includes a cured product of a resin composition including a fluorine compound including a reactive functional group and the polymerizable compound described below. Examples of the reactive functional group may include ethylenically unsaturated bonding groups such as a (meth) acryloyl group, a vinyl group, and an allyl group; an epoxy group; and an oxetanyl group.

The number of the reactive functional groups included in the fluorine compound may be 1 or more, and preferably 2 or more. By using a fluorine compound including 2 or more reactive functional groups, scuff resistance and abrasion resistance may be improved.

Also, the fluorine compound may include silicon. That is, the functional layer may include fluorine and silicon. Examples of the fluorine compound including silicon may include a fluorine compound including a siloxane bond in the molecule. By using the fluorine compound including a siloxane bond, sliding property may be improved, and scuff resistance may be improved. Also, since the sliding property when it is touched with a finger or a stylus pen may be improved, the texture may be improved.

The fluorine compound is preferably, for example, a fluorine compound including a reactive functional group; or a fluorine compound including a reactive functional group and silicon.

Examples of the fluorine compound including a reactive functional group may include a fluorine including monomer including an ethylenically unsaturated bond; a fluorine including polymer or oligomer including a fluoroalkylene group on the main chain; and a fluorine including polymer or oligomer including a fluoroalkylene group or fluoroalkyl group on the main chain and side chain. For fluorine compound including a reactive functional group, refer to, for example, Japanese Patent Application Laid-Open (JP-A) No. 2017-19247.

Examples of the fluorine compound including a reactive functional group and silicon may include a silicone including vinylidene fluoride copolymer obtained by reacting an organic silicone including a reactive functional group in the molecule, with the fluorine compound including a reactive functional group described above.

Also, for the fluorine compound including a reactive functional group and silicon, for example, a fluorine compound including a reactive functional group and a perfluoro polyether group, among the above, a fluorine compound including a silane unit including a reactive functional group and a silane unit including a perfluoro polyether group is also preferably used. For such fluorine compound, refer to, for example, WO2012/157682.

In the functional layer, for example, the fluorine compound may be evenly present, and may be unevenly distributed in the functional layer, on the opposite side surface to the substrate layer. Among the above, the fluorine compound is preferably unevenly distributed in the functional layer, on the opposite side surface to the substrate layer. Sufficient abrasion resistance and antifouling property may be obtained with a small adding amount, and the decrease in surface hardness of the functional layer may be suppressed.

Examples of a method for unevenly distributed the fluorine compound in the functional layer, on the opposite side surface to the substrate layer may include, when the functional layer is a single layer, a method wherein, during the formation of the functional layer, the fluorine compound is unevenly distributed in the functional layer, on the opposite side surface to the substrate layer, by coating the substrate layer with a resin composition for a functional layer, drying thereof, and before curing thereof, heating the coating film to reduce the viscosity of the resin component included in the coating film so as to increase the flowability; and a method wherein the fluorine compound is unevenly distributed in the functional layer, on the opposite side surface to the substrate layer, by using an fluorine compound with low surface tension, floating the fluorine compound on the surface of the coating film during the drying of the coating film without applying heat, and then, curing the coating film. Also, for example, when the functional layer is a multilayer, the fluorine compound may be unevenly distributed in the functional layer, on the opposite side surface to the substrate layer by, among the multilayer functional layer, compounding the fluorine compound in the layer located on the opposite side surface to the substrate layer.

The content of the fluorine compound is not particularly limited as long as it is an amount capable of obtaining a functional layer satisfying the absolute value of a charge amount described above, and is preferably, for example, 0.01 parts by mass or more and 15 parts by mass or less, with respect to 100 parts by mass of the resin component. When the content of the fluorine compound is too low, sufficient abrasion resistance or antifouling property may not be imparted to the functional layer. Also, when the content of the fluorine compound is too high, the surface hardness of the functional layer may decrease so that the abrasion resistance may decrease.

Also, for example, when the functional layer includes a fluorine compound and resin, examples of the resin may include a cured product of a polymerizable compound. The cured product of a polymerizable compound may be obtained by carrying out a polymerization reaction of a polymerizable compound, by a known method, using a polymerization initiator according to the needs.

The polymerizable compound includes at least one polymerizable functional group in the molecule. As the polymerizable compound, for example, at least one kind of radical polymerizable compound and cation polymerizable compound may be used.

The radical polymerizable compound is a compound including a radical polymerizable group. The radical polymerizable group included in the radical polymerizable compound may be any functional group capable of generating a radical polymerization reaction, and is not particularly limited; and examples thereof may include a group including a carbon-carbon unsaturated double bond, and specific examples thereof may include a vinyl group and a (meth) acryloyl group. Incidentally, when the radical polymerizable compound includes two or more radical polymerizable groups, these radical polymerizable groups may be the same, and may be different from each other.

The number of radical polymerizable groups included in one molecule of the radical polymerizable compound is preferably two or more, and more preferably three or more, from the viewpoint of increasing the surface hardness of the functional layer so that the scuff resistance is improved.

Among the above, from the viewpoint of high reactivity, the radical polymerizable compound is preferably a compound including a (meth) acryloyl group. For example, a polyfunctional (meth) acrylate monomer and oligomer having a molecular weight of several hundred to several thousand, and including several (meth) acryloyl groups in the molecule may be preferably used; such as those referred to as urethane (meth)acrylate, polyester (meth)acrylate, epoxy (meth)acrylate, melamine (meth)acrylate, polyfluoroalkyl (meth)acrylate, and silicone (meth)acrylate. Also, a polyfunctional (meth) acrylate polymer including two or more (meth) acryloyl groups on the side chain of an acrylate polymer may also be preferably used. Among the above, a polyfunctional (meth) acrylate monomer including two or more (meth) acryloyl groups in one molecule may be preferably used. By the functional layer including a cured product of the polyfunctional (meth) acrylate monomer, the surface hardness of the functional layer may be increased so that the scuff resistance may be improved. Further, the close adhesiveness may also be improved. Also, a polyfunctional (meth) acrylate oligomer or polymer including two or more (meth) acryloyl groups in one molecule may also be preferably used. By the functional layer including a cured product of the polyfunctional (meth) acrylate oligomer or polymer, the surface hardness of the functional layer may be increased so that the scuff resistance may be improved. Further, the bending resistance and close adhesiveness may also be improved.

Incidentally, in the present specification, (meth) acryloyl represents each of acryloyl and methacryloyl, and (meth) acrylate represents each of acrylate and methacrylate.

Specific examples of the polyfunctional (meth)acrylate monomer may include those described in, for example, JP-A No. 2019-132930. Among them, those having 3 or more and 6 or less (meth)acryloyl groups in one molecule are preferable from the viewpoint of high reactivity so that the surface hardness of the functional layer is increased and the scuff resistance is improved. As such a polyfunctional (meth)acrylate monomer, for example, pentaerythritol triacrylate (PETA), dipentaerythritol hexaacrylate (DPHA), pentaerythritol tetraacrylate (PETTA), dipentaerythritol pentaacrylate (DPPA), trimethylolpropane tri(meth)acrylate, tripentaerythritol octa(meth)acrylate, and tetrapentaerythritol deca(meth)acrylate may be preferably used. In particular, at least one kind selected from pentaerythritol tri(meth)acrylate, dipentaerythritol penta(meth)acrylate, and dipentaerythritol hexaacrylate is preferable.

Also, when the radical polymerizable compound is used, the scuff resistance may be decreased due to the flexible group in the molecular structure. Therefore, in order to suppress the decrease in the scuff resistance due to the flexible components (soft segments), it is preferable to use a radical polymerizable compound wherein a flexible group is not introduced into the molecular structure. Specifically, it is preferable to use a radical polymerizable compound that is not EO or PO modified. By using such a radical polymerizable compound, the crosslinking point may be increased and the scuff resistance may be improved.

In order to adjust the hardness or viscosity, or to improve the close adhesiveness, the functional layer may include a monofunctional (meth) acrylate monomer as the radical polymerizable compound. Specific examples of the monofunctional (meth) acrylate monomer may include those described in, for example, Japanese Patent Application Laid-Open (JP-A) No. 2019-132930.

The cation polymerizable compound is a compound including a cation polymerizable group. The cation polymerizable group included in the cation polymerizable compound may be a functional group capable of generating a cation polymerization reaction, and is not particularly limited; and examples thereof may include an epoxy group, an oxetanyl group, and a vinyl ether group. Incidentally, when the cation polymerizable compound includes two or more cation polymerizable groups, these cation polymerizable groups may be the same, and may be different from each other.

The number of the cation polymerizable groups included in one molecule of the cation polymerizable compound is preferably two or more, and more preferably three or more, from the viewpoint of increasing the surface hardness of the functional layer so that the scuff resistance is improved.

Also, among the above, as a cation polymerizable compound, a compound including at least one kind of an epoxy group and an oxetanyl group as a cation polymerizable group is preferable, and a compound including two or more of at least one kind of an epoxy groups and an oxetanyl groups in one molecule is more preferable. A cyclic ether group such as an epoxy group and an oxetanyl group is preferable from the viewpoint that shrinkage associated with the polymerization reaction is small. Also, a compound including the epoxy group among the cyclic ether groups has advantages in that compounds having various structure may be easily obtained; the durability of the obtained functional layer is not adversely affected; and the compatibility with the radical polymerizable compound may be easily controlled. Also, the oxetanyl group among the cyclic ether groups has advantaged in that the degree of polymerization is high compared with the epoxy group; the toxicity is low; and when the obtained functional layer is combined with a compound including an epoxy group, the network forming rate obtained from the cationic polymerizable compound in the coating film is accelerated, and an independent network is formed without leaving unreacted monomers in the film even in a region mixed with the radical polymerizable compound.

Examples of the cationic polymerizable compound including an epoxy group may include an alicyclic epoxy resins such as polyglycidyl ether of a polyhydric alcohol including an alicyclic ring, or resins obtained by epoxidizing a compound including a cyclohexene ring or a cyclopentene ring, with a suitable oxidizing agent such as hydrogen peroxide and a peracid; an aliphatic epoxy resins such as polyglycidyl ether of aliphatic polyhydric alcohol or alkylene oxide adduct thereof, polyglycidyl ester of aliphatic long-chain polybasic acid, or homopolymer or copolymer of glycidyl (meth)acrylate; a glycidyl ether type epoxy resin such as glycidyl ether produced by the reaction of bisphenols such as bisphenol A, bisphenol F, and hydrogenated bisphenol A, or derivative thereof such as alkylene oxide adduct and caprolactone adduct with epichlorohydrin, and resins that is novolac epoxy resin and derived from bisphenols.

Specific examples of the cationic polymerizable compound including the alicyclic epoxy resin, the glycidyl ether type epoxy resin, and an oxetanyl group may include those described in, for example, JP-A No. 2018-104682.

The functional layer may include a polymerization initiator if necessary. As the polymerization initiator, a radical polymerization initiator, a cation polymerization initiator, and a radical and cation polymerization initiator may be appropriately selected and used. These polymerization initiators are decomposed by at least one kind of light irradiation and heating to generate radicals or cations to cause radical polymerization and cation polymerization to proceed. Incidentally, all of the polymerization initiator may be decomposed and may not be left in the functional layer, in some cases.

Also, for example, when the functional layer includes fluorine resin, examples of the fluorine resin may include a cured product of a polymerizable compound including fluorine. The cured product of a polymerizable compound including fluorine may be obtained by carrying out a polymerization reaction of a polymerizable compound including fluorine, by a known method using a polymerization initiator according to the needs.

The polymerizable compound including fluorine includes at least one polymerizable functional group in the molecule. As the polymerizable compound including fluorine, for example, at least one kind of radical polymerizable compound and cation polymerizable compound may be used. Also, as the polymerizable compound including fluorine, for example, any one of fluorine-containing monomers, oligomers, and polymers may be used.

Also, when the functional layer includes fluorine resin, a polymerizable compound including no fluorine may be used, in addition to the polymerizable compound including fluorine. That is, the functional layer may include a cured product of a resin composition including a polymerizable compound including fluorine and a polymerizable compound including no fluorine. The polymerizable compound including no fluorine may be similar to the polymerized compounds used when the functional layer described above includes a fluorine compound and resin.

Also, the functional layer preferably includes an antistatic agent. Antistatic property may be imparted to the stacked body for a display device. Also, by adjusting the content of the antistatic agent, the absolute value of a charge amount on a functional layer side surface of the stacked body for a display device after an eraser test may be adjusted so as to be in a predetermined range.

Examples of the antistatic agent may include ion conductive type antistatic agents and electron conductive type antistatic agent. One kind of the antistatic agent may be used alone, and two kinds or more may be used in combination.

As the ion conductive type antistatic agent, for example, any one of a low molecular type antistatic agent and a high molecular type antistatic agent may be used. The high molecular type antistatic agent is obtained, for example, by increasing the molecular weight of the ion conductive type antistatic agent, or by introducing a conductivity imparting functional group of the ion conductive type antistatic agent into a polymer. Examples of the ion conductive type antistatic agent may include cationic antistatic agents such as quaternary ammonium salts and pyridium salts; anionic antistatic agents such as alkaline metal salts of sulfonic acid, phosphoric acid, carboxylic acid and so on such as lithium salts, sodium salts and potassium salts; amphoteric antistatic agents such as amino acid based and amino acid sulfate ester based; nonionic antistatic agents such as amino alcohol based, glycerin based and polyethylene glycol based; and ionic liquids. Among them, quaternary ammonium salts and lithium salts are preferable, since they exhibit excellent compatibility with resins.

Examples of the electron conductive type antistatic agents may include conductive polymers such as polyacetylene based and polythiophene based; conductive particles such as metal particles, metal oxide particles and carbon nanotubes; and conductive fibers. Also, antistatic agents obtained by combining a dopant with a conductive polymer such as polyacetylene and polythiophene; and antistatic agents wherein conductive particles are included in a conductive polymer may be used. Among these, in terms of maintaining antistatic property, the conductive polymers are preferable.

Specific examples of the conductive polymer may include conductive polymers such as polyacetylene, polyaniline, polythiophene, polypyrrole, polyphenylene sulfide, poly(1,6-heptadiine), polybiphenylene (polyparaphenylene), polyparaphenylene sulfide, polyphenylacetylene, poly(2,5-thienylene), or their derivatives. Preferable examples may include polythiophene based conductive polymers such as 3,4-ethylene dioxythiophene (PEDOT). By using the conductive polymer as an antistatic agent, antistatic property may be maintained for a long period of time.

Examples of the metal constituting the metal fine particles may include simple substances such as Au, Ag, Cu, Al, Fe, Ni, Pd, and Pt; or alloys of these metals.

The metal oxides constituting the metal oxide particles is not particularly limited, and examples thereof may include tin oxide, antimony oxide, antimony doped tin oxide (ATO), tin doped indium oxide (ITO), aluminum doped zinc oxide (AZO), fluorine doped tin oxide (FTO), and zinc oxide (ZnO). In particular, antimony doped tin oxide (ATO) is preferable in view of its excellent antistatic property. Also, among ATO, chain-shaped ATO including a plurality of linked ATO particles is preferable.

Among the above antistatic agents, the polymer type antistatic agent and conductive polymer are preferable, and the conductive polymer is more preferable. The polymer type antistatic agent and conductive polymer are able to impart antistatic property even in small quantities, and are able to maintain surface hardness and optical properties.

Also, when the functional layer includes the antistatic agent, and also the functional layer is multilayer as described below, the antistatic agent may be included in at least one layer among the multilayer functional layer.

In this case, any one of the multilayer functional layers may include the antistatic agent. Among the above, a layer closer to the surface opposite to the substrate layer preferably includes the antistatic agent, and in particular, a layer located on the opposite side surface to the substrate layer, that is, the outermost layer, among the multilayer functional layer, preferably includes the antistatic agent. This is because the closer the distance between the surface on which the eraser test is carried out and the layer including the antistatic agent, the easier it is to adjust the absolute value of a charge amount, on the functional layer side surface of the stacked body for a display device after the eraser test, to be in a predetermined range.

The content of the antistatic agent is not particularly limited as long as it is an amount capable of obtaining a functional layer satisfying the absolute value of a charge amount described above, and is appropriately selected according to the type and so on of the antistatic agent. The content of the antistatic agent is preferably, for example, 0.1 parts by mass or more and 100 parts by mass or less, more preferably 0.2 part by mass or more and 50 parts by mass or less, and further preferably 0.3 parts by mass or more and 20 parts by mass or less, with respect to 100 parts by mass of the resin component. When the content of the antistatic agent is too low, sufficient antistatic property may not be imparted to the functional layer. Also, when the content of the antistatic agent is too high, the surface hardness of the functional layer may decrease so that the abrasion resistance may decrease. Incidentally, when the functional layer includes the antistatic agent, and also the functional layer is multilayer as described below, the content of the antistatic agent in a layer including the antistatic agent, among the multilayer functional layer, is preferably in the above range.

The functional layer may include an additive such as inorganic particles, organic particles, ultraviolet absorbers, antioxidants, light stabilizers, antiglare agents, leveling agents, surfactants, easy lubricants, various sensitizers, flame retardants, adhesive imparting agents, polymerization inhibitor, and surface modifiers, if necessary.

The functional layer may be a single layer, and may be a multilayer.

The thickness of the functional layer is not particularly limited as long as it is a thickness capable of obtaining a functional layer satisfying the properties described above, and is preferably, for example, 0.5 μm or more and 50 μm or less, more preferably 1.0 μm or more and 40 μm or less, and further preferably 1.5 μm or more and 30 μm or less. When the thickness of the functional layer is too thin, the surface hardness of the functional layer may decrease so that the abrasion resistance may decrease. Also, when the thickness of the functional layer is too thick, the flexibility may be deteriorated. Incidentally, as described above, by adjusting the thickness of the functional layer, the absolute value of a charge amount on a functional layer side surface of the stacked body for a display device after an eraser test may be adjusted so as to be in a predetermined range. Also, when the functional layer is multilayer, the thickness of the layer located on the opposite side surface to the substrate layer, among the multilayer functional layer, is preferably in the above range.

Here, the thickness of the functional layer may be the average value of the thickness of arbitrary 10 points obtained by measuring from the thickness directional cross-section of the stacked body for a display device by observing with a transmission electron microscope (TEM), a scanning electron microscope (SEM) or a scanning transmission electron microscope (STEM). Incidentally, the same may be applied to the measuring methods of the thickness of other layers included in the stacked body for a display device.

The functional layer may be placed on one surface of the substrate layer; among the above, the functional layer is preferably placed on the outermost surface in the stacked body for a display device.

Examples of a method for forming a functional layer may include a method wherein the substrate layer is coated with a resin composition for a functional layer, and cured.

### 3. Substrate Layer

The substrate layer in the present disclosure is a member configured to support the functional layer, and has transparency.

The substrate layer is not particularly limited as long as it has transparency; and examples thereof may include a resin substrate, and a glass substrate.

### (1) Resin Substrate

The resin constituting the resin substrate is not particularly limited as long as it is able to obtain a resin substrate having transparency; and examples thereof may include a polyimide based resin, a polyamide based resin, and a polyester based resin. Examples of the polyimide based resin may include polyimide, polyamideimide, polyetherimide, and polyesterimide. Examples of the polyester based resin may include polyethylene terephthalate, polypropylene terephthalate, polybutylene terephthalate, and polyethylene naphthalate. Among them, from the viewpoint of having bending resistance, excellent hardness and transparency, the polyimide based resin, the polyamide based resin, or a mixture thereof is preferable, and the polyimide based resin is more preferable.

The polyimide based resin is not particularly limited as long as it is able to obtain a resin substrate having transparency; and among the above, polyimide and polyamideimide are preferably used.

### (a) Polyimide

The polyimide is obtained by reacting a tetracarboxylic acid component and a diamine component. The polyimide is not particularly limited as long as it has transparency and stiffness; and it is preferable to have at least one kind of the structure selected from the group consisting of the structure represented by the following general formula (1) and the following general formula (3), for example, from the viewpoint of having excellent transparency and excellent stiffness.

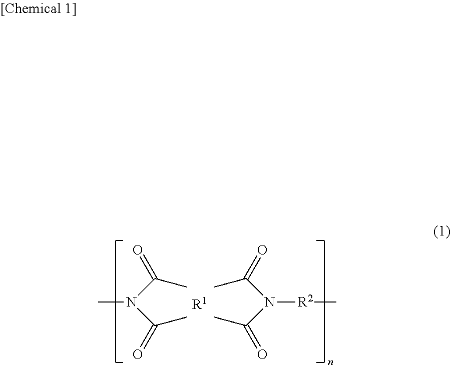

In the general formula (1), R¹ represents a tetravalent group which is a tetracarboxylic acid residue; and R² represents at least one kind of divalent group selected from the group consisting of a trans-cyclohexanediamine residue, a trans-1,4-bismethylenecyclohexanediamine residue, a 4,4′-diaminodiphenylsulfone residue, a 3,4′-diaminodiphenylsulfone residue, and a divalent group represented by the following general formula (2). The “n” represents the number of repeating units, and is 1 or more.

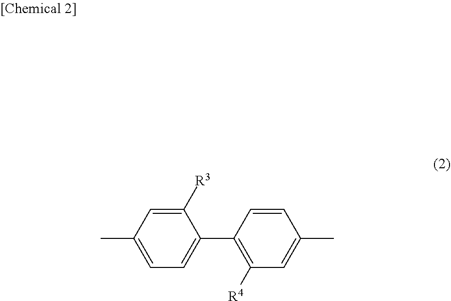

In the general formula (2), R³ and R⁴ each independently represents a hydrogen atom, an alkyl group, or a perfluoro alkyl group.

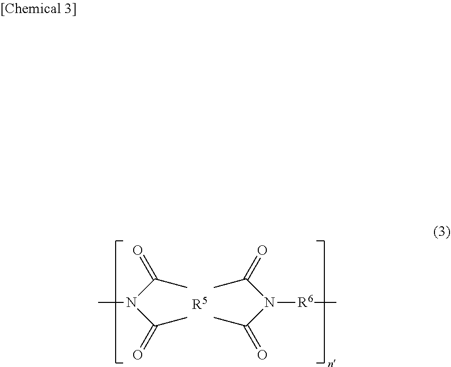

In the general formula (3), R⁵ represents at least one kind of tetravalent group selected from the group consisting of a cyclohexane tetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; and R⁶ represents a divalent group which is a diamine residue. The “n′” represents the number of repeating units, and is 1 or more.

Incidentally, “tetracarboxylic acid residue” refers to a residue obtained by excluding four carboxyl groups from a tetracarboxylic acid; and represents the same structure as a residue obtained by excluding an acid dianhydride structure from a tetracarboxylic acid dianhydride. Also, “diamine residue” refers to a residue obtained by excluding two amino groups from a diamine.

In the general formula (1), R¹ is a tetracarboxylic acid residue, and may be a residue obtained by excluding an acid dianhydride structure from a tetracarboxylic acid dianhydride. Examples of the tetracarboxylic acid dianhydride may include those described in WO 2018/070523. Among them, R¹ in the general formula (1) preferably includes at least one kind selected from the group consisting of a 4,4′-(hexafluoroisopropylidene)diphthalic acid residue, a 3,3′,4,4′-biphenyltetracarboxylic acid residue, pyromellitic acid residue, a 2,3′,3,4′-biphenyltetracarboxylic acid residue, a 3,3′,4,4′-benzophenone tetracarboxylic acid residue, a 3,3′,4,4′-diphenylsulfone tetracarboxylic acid residue, a 4,4′-oxydiphthalic acid residue, a cyclohexane tetracarboxylic acid residue, and a cyclopentane tetracarboxylic acid residue, from the viewpoint of improved transparency and improved stiffness. It is further preferable to include at least one kind selected from the group consisting of a 4,4′-(hexafluoroisopropylidene)diphthalic acid residue, a 4,4′-oxydiphthalic acid residue and a 3,3′,4,4′-diphenylsulfone tetracarboxylic acid residue.

In R¹, these preferable residues are preferably included in total of 50 mol % or more, more preferably 70 mol % or more, and further preferably 90 mol % or more.

Also, as R¹, it is also preferable to use a mixture of the followings: a tetracarboxylic acid residue group (Group A) suitable for improving rigidity such as at least one kind selected from the group consisting of a 3,3′,4,4′-biphenyltetracarboxylic acid residue, a 3,3′,4,4′-benzophenone tetracarboxylic acid residue, and a pyromellitic acid residue; and a tetracarboxylic acid residue group (Group B) suitable for improving transparency such as at least one kind selected from the group consisting of a 4,4′-(hexafluoroisopropylidene)diphthalic acid residue, a 2,3′,3,4′-biphenyltetracarboxylic acid residue, a 3,3′,4,4′-diphenylsulfone tetracarboxylic acid residue, a 4,4′-oxydiphthalic acid residue, a cyclohexane tetracarboxylic acid residue, and a cyclopentanetetracarboxylic acid residue.

In this case, in relation to the content ratio of the tetracarboxylic acid residue group suitable for improving the rigidity (Group A) and the tetracarboxylic acid residue group suitable for improving transparency (Group B), with respect to 1 mol of the tetracarboxylic acid residue group suitable for improving transparency (Group B), the tetracarboxylic acid residue group suitable for improving rigidity (Group A) is preferably 0.05 mol or more and 9 mol or less, more preferably 0.1 mol or more and 5 mol or less, and further preferably 0.3 mol or more and 4 mol or less.

Among them, R² in the general formula (1) is preferably at least one kind of divalent group selected from the group consisting of a 4,4′-diaminodiphenylsulfone residue, a 3,4′-diaminodiphenylsulfone residue, and a divalent group represented by the general formula (2); and is further preferably at least one kind of divalent group selected from the group consisting of a 4,4′-diaminodiphenylsulfone residue, a 3,4′-diaminodiphenylsulfone residue, and a divalent group represented by the general formula (2) wherein R³ and R⁴ are a perfluoro alkyl group, from the viewpoint of improved transparency and improved stiffness.

Among them, from the viewpoint of improved transparency and improved stiffness, R⁵ in the general formula (3) preferably includes a 4,4′-(hexafluoroisopropylidene) diphthalic acid residue, a 3,3′,4,4′-diphenylsulfontetracarboxylic acid residue, and oxydiphthalic acid residue.

The R⁵ preferably includes 50 mol % or more, more preferably 70 mol % or more, and further preferably 90 mol % or more of these preferable residues.

The R⁶ in the general formula (3) is a diamine residue, and may be a residue obtained by excluding two amino groups from a diamine. Examples of the diamine may include those described in, for example, WO 2018/070523. Among them, from the viewpoint of improved transparency and improved stiffness, R⁶ in the general formula (3) preferably includes at least one kind of divalent group selected from the group consisting of a 2,2′-bis(trifluoromethyl)benzidine residue, a bis[4-(4-aminophenoxy)phenyl]sulfone residue, a 4,4′-diaminodiphenylsulfone residue, a 2,2-bis[4-(4-aminophenoxy)phenyl]hexafluoropropane residue, a bis[4-(3-aminophenoxy)phenyl]sulfone residue, a 4,4′-diamino-2,2′-bis(trifluoromethyl)diphenylether residue, a 1,4-bis[4-amino-2-(trifluoromethyl)phenoxy]benzene residue, a 2,2-bis[4-(4-amino-2-trifluoromethylphenoxy)phenyl]hexafluoropropane residue, a 4,4′-diamino-2-(trifluoromethyl)diphenyl ether residue, a 4,4′-diaminobenzanilide residue, a N,N′-bis(4-aminophenyl)terephthalamide residue and a 9,9-bis(4-aminophenyl)fluorene residue; and further preferably includes at least one kind of divalent group selected from the group consisting of a 2,2′-bis(trifluoromethyl)benzidine residue, a bis[4-(4-aminophenoxy)phenyl]sulfone residue, and a 4,4′-diaminodiphenylsulfone residue.

In R⁶, these preferable residues are preferably included in total of 50 mol % or more, more preferably 70 mol % or more, and further preferably 90 mol % or more.

Also, as R⁶, it is also preferable to use a mixture of the followings: a diamine residue group (Group C) suitable for improving rigidity such as at least one kind selected from the group consisting of a bis[4-(4-aminophenoxy)phenyl]sulfone residue, a 4,4′-diaminobenzanilide residue, a N,N′-bis(4-aminophenyl)terephthalamide residue, a paraphenylenediamine residue, a metaphenylenediamine residue, and a 4,4′-diaminodiphenylmethane residue; and a diamine residue group (Group D) suitable for improving transparency such as at least one kind selected from the group consisting of a 2,2′-bis(trifluoromethyl)benzidine residue, a 4,4′-diaminodiphenyl sulfone residue, a 2,2-bis[4-(4-aminophenoxy)phenyl] hexafluoropropane residue, a bis[4-(3-aminophenoxy)phenyl] sulfone residue, a 4,4′-diamino-2,2′-bis(trifluoromethyl)diphenylether residue, a 1,4-bis[4-amino-2-(tirfluoromethyle)phenoxy] benzene residue, a 2,2-bis[4-(4-amino-2-trifluoromethylphenoxy)phenyl]hexafluoropropane residue, a 4,4′-diamino-2(trifluoromethyl)diphenylether residue, and a 9,9-bis(4-aminophenyl)fluorene residue.

In this case, in relation to the content ratio of the diamine residue group suitable for improving rigidity (Group C) and the diamine residue group suitable for improving transparency (Group D), with respect to 1 mol of the diamine residue group suitable for improving transparency (Group D), the diamine residue group suitable for improving rigidity (Group C) is preferably 0.05 mol or more and 9 mol or less, more preferably 0.1 mol or more and 5 mol or less, and further preferably 0.3 mol or more and 4 mol or less.

In the structure represented by the general formula (1) and the general formula (3), “n” and “n′” each independently represents the number of repeating units, and is 1 or more. The number of repeating units “n” in the polyimide may be appropriately selected according to the structure, and is not particularly limited. The average number of repeating units may be, for example, 10 or more and 2000 or less, and is preferably 15 or more and 1000 or less.

Also, the polyimide may include a polyamide structure in a part thereof. Examples of the polyamide structure that may be included may include a polyamideimide structure including a tricarboxylic acid residue such as trimellitic acid anhydride; and a polyamide structure including a dicarboxylic acid residue such as terephthalic acid.

From the viewpoint of improved transparency and improved surface hardness, at least one of the tetravalent group which is a tetracarboxylic acid residue of R¹ or R⁵, and the divalent group which is a diamine residue of R² or R⁶ preferably includes an aromatic ring; and preferably includes at least one selected from the group consisting of (i) a fluorine atom, (ii) an aliphatic ring, and (iii) a structure wherein aromatic rings are connected to each other by an alkylene group which may be substituted with a sulfonyl group or a fluorine. When the polyimide includes at least one kind selected from a tetracarboxylic acid residue including an aromatic ring, and a diamine residue including an aromatic ring, the molecular skeleton becomes rigid, the orientation property is increased, and the surface hardness is improved; however, the absorption wavelength of the rigid aromatic ring skeleton tends to be shifted to the longer wavelength side, and the transmittance of the visible light region tends to be decreased. Meanwhile, when the polyimide includes (i) a fluorine atom, the transparency is improved since it may make the electronic state in the polyimide skeleton to a state wherein a charge transfer is difficult.

Also, when the polyimide includes (ii) an aliphatic ring, transparency is improved since the transfer of charge in the skeleton may be inhibited by breaking the conjugation of n electrons in the polyimide skeleton. Also, when the polyimide includes (iii) a structure wherein aromatic rings are connected to each other by an alkylene group which may be substituted with a sulfonyl group or a fluorine, transparency is improved since the transfer of charge in the skeleton may be inhibited by breaking the conjugation of n electrons in the polyimide skeleton.

Among them, from the viewpoint of improved transparency and improved surface hardness, at least one of the tetravalent group which is a tetracarboxylic acid residue of R¹ or R⁵, and the divalent group which is a diamine residue of R² or R⁶ preferably includes an aromatic ring and a fluorine atom; and the divalent group which is a diamine residue of R² or R⁶ preferably includes an aromatic ring and a fluorine atom.

Specific examples of such polyimide may include those having a specific structure described in WO 2018/070523.

The polyimide may be synthesized by a known method. Also, a commercially available polyimide may be used. Examples of the commercially available products of polyimide may include Neopulim (registered trademark) from Mitsubishi Gas Chemical Company, Inc.

The weight average molecular weight of the polyimide is preferably, for example, 3000 or more and 500,000 or less, more preferably 5000 or more and 300,000 or less, and further preferably 10,000 or more and 200,000 or less. When the weight average molecular weight is too low, sufficient strength may not be obtained, and when the weight average molecular weight is too high, the viscosity is increased and the solubility is decreased, so that a substrate layer having a smooth surface and uniform thickness may not be obtained in some cases.

Incidentally, the weight average molecular weight of the polyimide may be measured by gel permeation chromatography (GPC). Specifically, the polyimide is used as a N-methylpyrrolidone (M4P) solution having a concentration of 0.1% by mass; a 30 mmol % LiBr-NMP solution with a water content of 500 ppm or less is used as a developing solvent; and measurement is carried out using a GPC device (HLC-8120, used column: GPC LF-804 from SHODEX) from Tosoh Corporation, under conditions of a sample injecting amount of 50 μL, a solvent flow rate of 0.4 mL/min, and at 37° C. The weight average molecular weight is determined on the basis of a polystyrene standard sample having the same concentration as that of the sample.

### (b) Polyamideimide

The polyamideimide is not particularly limited as long as it is able to obtain a resin substrate having transparency; and examples thereof may include those having a first block including a constituent unit derived from dianhydride, and a constituent unit derived from diamine; and a second block including a constituent unit derived from aromatic dicarbonyl compound, and a constituent unit derived from aromatic diamine. In the polyamideimide described above, the dianhydride may include, for example, biphenyltetracarboxylic acid dianhydride (BPDA) and 2-bis(3,4-dicarboxyphenyl)hexafluoropropanedianhydride (6FDA). Also, the diamine may include bistrifluoromethylbenzidine (TFDB). That is, the polyamideimide has a structure wherein a polyamideimide precursor including a first block wherein monomers including dianhydride and diamine are copolymerized; and a second block wherein monomers including an aromatic dicarbonyl compound and an aromatic diamine are copolymerized, is imidized.

By including the first block including an imide bond and the second block including an amide bond, the polyamideimide is excellent in not only optical properties but also thermal and mechanical properties. In particular, by using bistrifluoromethylbenzidine (TFDB) as the diamine forming the first block, thermal stability and optical properties may be improved. Also, by using 2-bis(3,4-dicarboxyphenyl)hexafluoropropane dianhydride (6FDA) and biphenyltetracarboxylic acid dianhydride (BPDA) as the dianhydride forming the first block, birefringence may be improved, and heat resistance may be secured.

The dianhydride forming the first block comprises two kinds of dianhydrides, that is, 6FDA and BPDA. In the first block, a polymer to which TFDB and 6FDA are bonded, and a polymer to which TFDB and BPDA are bonded may be included, based on separate repeating units, respectively segmented; may be regularly arranged within the same repeating unit; or may be included in a completely random arrangement.

Among the monomers forming the first block, BPDA and 6FDA are preferably included as dianhydrides in a molar ratio of 1:3 to 3:1. This is because it is possible not only to secure the optical properties, but also to suppress deterioration of mechanical properties and heat resistance, and it is possible to have excellent birefringence.

The molar ratio of the first block and the second block is preferably 5:1 to 1:1. When the content of the second block is remarkably low, the effect of improving the thermal stability and mechanical properties due to the second block may not be sufficiently obtained in some cases. Also, when the content of the second block is higher than the content of the first block, although the thermal stability and mechanical properties may be improved, optical properties such as yellowness and transmittance may be deteriorated, and the birefringence property may also be increased in some cases.

Incidentally, the first block and the second block may be random copolymers, and may be block copolymers. The repeating unit of the block is not particularly limited.

Examples of the aromatic dicarbonyl compound forming the second block may include one kind or more selected from the group consisting of terephthaloyl chloride (p-terephthaloyl chloride, TPC), terephthalic acid, iso-phthaloyl dichloride, and 4,4′-benzoyl dichloride (4,4′-benzoyl chloride). One kind or more selected from terephthaloyl chloride (p-terephthaloyl chloride, TPC) and iso-phthaloyl dichloride may be preferably used.

Examples of the diamine forming the second block may include diamines including one kind or more flexible group selected from the group consisting of 2,2-bis(4-(4-aminophenoxy)phenyl)hexafluoropropane (HFBAPP), bis(4-(4-aminophenoxy)phenyl)sulfone (BAPS), bis(4-(3-aminophenoxy)phenyl)sulfone (BAPSM), 4,4′-diaminodiphenyl sulfone (4DDS), 3,3′-diaminodiphenyl sulfone (3DDS), 2,2-bis(4-(4-aminophenoxy)phenylpropane (BAPP), 4,4′-diaminodiphenylpropane (6HDA), 1,3-bis(4-aminophenoxy)benzene (134APB), 1,3-bis(3-aminophenoxy)benzene (133APB), 1,4-bis(4-aminophenoxy)biphenyl (BAPB), 4,4′-bis(4-amino-2-trifluoromethylphenoxy)biphenyl (6FAPBP), 3,3-diamino-4,4-dihydroxydiphenylsulfone (DABS), 2,2-bis(3-amino-4-hydroxyloxyphenyl)propane (BAP), 4,4′-diaminodiphenylmethane (DDM), 4,4′-oxydianiline (4-ODA) and 3,3′-oxydianiline (3-ODA).

When the aromatic dicarbonyl compound is used, it is easy to realize high thermal stability and mechanical properties, but may exhibit high birefringence due to the benzene ring in the molecular structure. Therefore, in order to suppress the decrease in birefringence due to the second block, it is preferable to use a diamine wherein a flexible group is introduced into the molecular structure. Specifically, the diamine is more preferably one kind or more diamine selected from bis(4-(3-aminophenoxy)phenyl)sulfone (BAPSM), 4,4′-diaminodiphenylsulfone (4DDS) and 2,2-bis(4-(4-aminophenoxy)phenyl)hexafluoropropane (HFBAPP). In particular, the longer the length of the flexible group such as BAPSM, and a diamine including a substituent at meta position, the better the birefringence may be exhibited.

For the polyamideimide precursor including a first block wherein a dianhydride including a biphenyltetracarboxylic acid dianhydride (BPDA) and a 2-bis(3,4-dicarboxyphenyl)hexafluoropropanedianhydride (6FDA), and a diamine including bistrifluoromethylbenzidine (TFDB) are copolymerized; and a second block wherein an aromatic dicarbonyl compound and an aromatic diamine are copolymerized, in the molecular structure, the weight average molecular weight measured by GPC is preferably, for example, 200,000 or more and 215,000 or less, and the viscosity is preferably, for example, 2400 poise or more and 2600 poise or less.

The polyamideimide may be obtained by imidizing a polyamideimide precursor. Also, a polyamideimide film may be obtained using the polyamideimide. For a method for imidizing the polyamideimide precursor and a method for producing a polyamideimide film, JP-A No. 2018-506611, for example, may be referred.

### (2) Glass Substrate

The glass constituting the glass substrate is not particularly limited as long as it has transparency; and examples thereof may include silicate glass and silica glass. Among them, borosilicate glass, aluminosilicate glass, and aluminoborosilicate glass are preferable, and alkali-free glass is more preferable. Examples of the commercial products of the glass substrate may include ultra-thin plate glass G-Leaf from Nippon Electric Glass Co., Ltd., and ultra-thin film glass from Matsunami Glass Ind., Ltd.

Also, the glass constituting the glass substrate is preferably a chemically strengthened glass. The chemically strengthened glass is preferable since it has excellent mechanical strength and may be made thin accordingly. The chemically strengthened glass is typically a glass wherein mechanical properties are strengthened by a chemical method by partially exchanging ionic species, such as by replacing sodium with potassium, in the vicinity of the surface of glass, and includes a compressive stress layer on the surface.

Examples of the glass constituting the chemically strengthened glass substrate may include aluminosilicate glass, soda-lime glass, borosilicate glass, lead glass, alkali barium glass, and aluminoborosilicate glass.

Examples of the commercial products of the chemically strengthened glass substrate may include Gorilla Glass from Corning Incorporated, Dragontrail from AGC Inc., and chemically strengthened glass from Schott Ag.

### (3) Constitution of Substrate Layer

Among the above, the substrate layer is preferably a polyimide based resin substrate including polyimide based resin, or a glass substrate. This is because it has bending resistance, and may be a substrate layer with excellent hardness and transparency.

The thickness of the substrate layer is not particularly limited as long as it has a thickness capable of having flexibility, and is appropriately selected according to the type of the substrate layer.

The thickness of the resin substrate is preferably, for example, 10 μm or more and 100 μm or less, and more preferably 25 μm or more and 80 μm or less. When the thickness of the resin substrate is in the above range, excellent flexibility may be obtained, and at the same time, sufficient hardness may be obtained. It is also possible to suppress curling of the stacked body for a display device. Furthermore, it is preferable in terms of reducing the weight of the stacked body for a display device.

The thickness of the glass substrate is preferably, for example, 200 μm or less, more preferably 15 μm or more and 100 μm or less, further preferably 20 μm or more and 90 μm or less, and particularly preferably 25 μm or more and 80 μm or less. When the thickness of the glass substrate is in the above range, excellent flexibility may be obtained, and at the same time, sufficient hardness may be obtained. It is also possible to suppress curling of the stacked body for a display device. Furthermore, it is preferable in terms of reducing the weight of the stacked body for a display device.

### 4. Second Functional Layer

The stacked body for a display device in the present disclosure may include a second functional layer between the substrate layer and the functional layer, or on the functional layer, on the opposite side to the substrate layer. Examples of the second functional layer may include a hard coating layer, antireflection layer, an antiglare layer, a scattering prevention layer and a primer layer.

Also, the second functional layer may be a single layer, and may be a multilayer. Also, the second functional layer may be a layer having a single function, and may include a plurality of layers having functions different from each other.

### (1) Hard Coating Layer

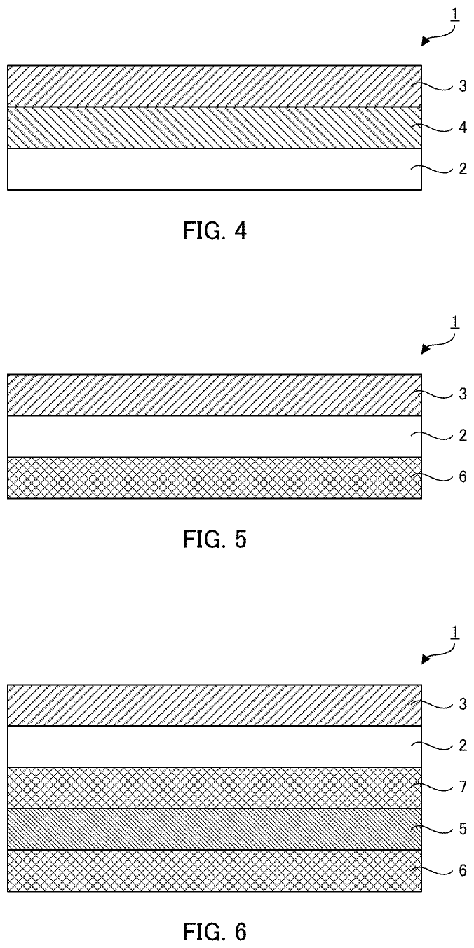

For example, as shown in FIG. 4, the stacked body for a display device in the present disclosure may include a hard coating layer 4 between the substrate layer 2 and the functional layer 3. The hard coating layer is a member to enhance the surface hardness. By placing the hard coating layer, scratch resistance may be improved. Particularly, when the substrate layer is a resin substrate, the scratch resistance may be effectively improved by placing the hard coating layer.

As a material of the hard coating layer, for example, an organic material, an inorganic material, and an organic-inorganic composite material may be used.

Among the above, the material of the hard coating layer is preferably an organic material. Specifically, the hard coating layer preferably include a cured product of a resin composition including a polymerizable compound. The cured product of a resin composition including a polymerizable compound may be obtained by carrying out a polymerization reaction of a polymerizable compound, by a known method using a polymerization initiator if necessary.

Incidentally, since the polymerizable compound may be similar to those described in the section of the functional layer above, the explanation is omitted herein.

The hard coating layer may include a polymerization initiator if necessary. Incidentally, since the polymerization initiator may be similar to those described in the section of the functional layer above, the explanation is omitted herein.

Also, the hard coating layer may include an antistatic agent. Above all, when the functional layer does not include an antistatic agent, the hard coating layer preferably includes an antistatic agent. The stacked body for a display device may be imparted with an antistatic property. Also, by adjusting the content of the antistatic agent, the absolute value of a charge amount on a functional layer side surface of the stacked body for a display device after an eraser test may be adjusted so as to be in a predetermined range.

The type and content of the antistatic agent may be similar to the type and content of the antistatic agent in the functional layer.

The hard coating layer may further include an additive if necessary. The additive is appropriately selected according to the function imparted to the hard coating layer, and is not particularly limited. Examples thereof may include inorganic particles, organic particles, ultraviolet absorbers, infrared absorbers, antifoulants, antiglare agents, leveling agents, surfactants, easy lubricants, various sensitizers, flame retardants, adhesive imparting agents, polymerization inhibitors, antioxidants, light stabilizers and surface modifiers.

The thickness of the hard coating layer may be appropriately selected according to the function of the hard coating layer and the use application of the stacked body for a display device. The thickness of the hard coating layer is preferably, for example, 0.5 μm or more and 50 μm or less, more preferably 1.0 μm or more and 40 μm or less, further preferably 1.5 μm or more and 30 μm or less, and particularly preferably 2 μm or more and 20 μm or less. When the thickness of hard coating layer is in the above range, sufficient hardness as the hard coating layer may be obtained.

Examples of a method for forming a hard coating layer may include a method wherein the substrate layer is coated with a resin composition for a hard coating layer including the polymerizable compound, and cured.

### (2) Antireflection Layer

The stacked body for a display device in the present disclosure may include an antireflection layer as a second functional layer. The antireflection layer is usually provided on the functional layer, on the opposite side surface to the substrate layer.

The antireflection layer may be a single layer, and may be a multilayer.

As an antireflection layer, a general antireflection layer may be applied, examples thereof may include a single layer including a material with a lower refractive index than the hard coating layer; a multilayer including a high refractive index layer and a low refractive index layer from the hard coating layer side; a multilayer wherein a high refractive index layer and a low refractive index layer are stacked alternately from the hard coating layer side; and a multilayer including a medium refractive index layer, a high refractive index layer, and a low refractive index layer in order from the hard coating layer side.

When the antireflection layer is a single layer, the material included in the single layer may be a material with a lower refractive index than the hard coating layer, and examples thereof may include magnesium fluoride.

Also, when the antireflection layer is a multilayer, the refractive index of the low refractive index layer is preferably, for example 1.45 or less, and more preferably 1.40 or less. By setting the refractive index of the low refractive index layer in the above range, good antireflection property may be obtained. Also, the lower limit of the refractive index of the low refractive index layer is practically 1.10 or more.

Examples of the low refractive index layer may include those including a hydrolytic polycondensate of a metallic alkoxide; those including resin with low refractive index; those including low refractive index particles; those including a binder resin and low refractive index particles.

The hydrolytic polycondensate of a metal alkoxide may be obtained, for example, by the sol gel method.

Examples of the resin with low refractive index may include fluorine resins.

Also, the thickness of the low refractive index layer is preferably approximately ¼ of the wavelength range of the visible light (around 100 nm) so that it is preferably, for example, 60 nm or more and 200 nm or less, more preferably 75 nm or more and 180 nm or less, and further preferably 90 nm or more and 150 nm or less.

Examples of the method for forming a low refractive index layer may include a wet method and a dry method. Examples of the wet method may include a forming method using metallic alkoxide and so on by a sol-gel method; a forming method by applying a resin with a low refractive index; and a forming method by applying a composition for a low refractive index layer including a binder resin and low refractive index particles. Examples of the dry method may include a forming method by a physical vapor deposition method or a chemical vapor deposition method using low refractive index particles. The wet method is superior in terms of production efficiency, and among them, the forming method by applying a composition for a low refractive index layer including a binder resin and low refractive index particles, is preferable.

Also, the refractive index of the high refractive index layer is preferably, for example, 1.55 or more and 1.85 or less, and more preferably 1.58 or more and 1.70 or less. By setting the refractive index of the high refractive index layer at a predetermined value or more, good antireflection property may be obtained. Also, the upper limit of the refractive index of the high refractive index layer is practically 1.85 or less.

Examples of the high refractive index layer may include one including a binder resin and high refractive index particles.

Examples of the high refractive index particles may include antimony pentoxide, zinc oxide, titanium oxide, cerium oxide, tin-doped indium oxide, antimony-doped tin oxide, yttrium oxide and zirconium oxide.

The average particle size of the high refractive index particles is preferably, for example, 5 nm or more and 200 nm or less, more preferably 5 nm or more and 100 nm or less, and further preferably 10 nm or more and 80 nm or less. By setting the average particle size to 5 nm or more, it is easy to suppress the aggregation of the particles, and by setting the average particle size to 200 nm or less, the deterioration of visibility, caused by whitening due to particle diffusion, may be easily suppressed.

From the viewpoint of the balance between the higher refractive index of the coating film and the strength of the coating film, the content of the high refractive index particles is preferably 50 parts by mass or more and 500 parts by mass or less, more preferably 100 parts by mass or more and 450 parts by mass or less, and further preferably 200 parts by mass or more and 430 parts by mass or less, with respect to 100 parts by mass of the binder resin.

Examples of the binder resin included in the high refractive index layer may include a cured product of a curable resin composition. As the curable resin composition, those similar to the examples used for the hard coating layer may be used, and a photocurable resin composition is preferable.

Also, the thickness of the high refractive index layer is preferably, for example, 200 nm or less, more preferably 50 nm or more and 180 nm or less, and further preferably 90 nm or more and 160 nm or less. By setting the thickness of the high refractive index layer to the above range, low reflectivity may be exhibited in a wide wavelength range in the visible light range (380 nm to 780 nm).

Examples of the method for forming a high refractive index layer may include a forming method by applying a composition for a high refractive index layer including a binder resin and high refractive index particles.

The thickness of the antireflection layer may be similar to the thickness of a general antireflection layer, and it is appropriately selected according to the layer structure of the antireflection layer.

Examples of the method for forming an antireflection layer may include a coating method, and a vapor deposition method, and is appropriately selected according to the material and so on of the antireflection layer.

### 5. Impact Absorbing Layer

The stacked body for a display device in the present disclosure may include an impact absorbing layer on the substrate layer, on an opposite side surface to the functional layer, or between the substrate layer and the functional layer. By placing the impact absorbing layer, when an impact is imparted to the stacked body for a display device, the impact is absorbed so that the impact resistance may be improved. Also, when the substrate layer is a glass substrate, the crack of the glass substrate may be suppressed.

The material of the impact absorbing layer is not particularly limited as long as it is capable of obtaining an impact absorbing layer having an impact absorbing property, and transparency, and examples thereof may include polyethylene terephthalate (PET), polyethylene naphthalate (PEN), urethane resin, epoxy resin, polyimide, polyamideimide, acrylic resin, triacetyl cellulose (TAC), and silicone resin. One kind of these materials may be used alone, and two kinds or more may be used in combination.

The impact absorbing layer may further include an additive if necessary. Examples of the additive may include inorganic particles, organic particles, an ultraviolet absorber, an antioxidant, a light stabilizer, a surfactant, and an adhesive improving agent.

The thickness of the impact absorbing layer may be the thickness capable of absorbing an impact, and is preferably, for example, 7 μm or more and 150 μm or less, more preferably 10 μm or more and 120 μm or less, and further preferably 15 μm or more and 100 μm or less.

As the impact absorbing layer, for example, a resin film may be used. Also, for example, the impact absorbing layer may be formed by coating the substrate layer with a composition for an impact absorbing layer.

### 6. Adhesive Layer for Adhesion

For example, as shown in FIG. 5, the stacked body for a display device in the present disclosure may include adhesive layer for adhesion 6 on the substrate layer 2, on an opposite surface side to the functional layer 3. The stacked body for a display device may be adhered to, for example, a display panel via the adhesive layer for adhesion.

The adhesive used for the adhesive layer for adhesion is not particularly limited as long as it is an adhesive having transparency, and is capable of adhering the stacked body for a display device to, for example, a display panel. Examples thereof may include a thermosetting adhesive, an ultraviolet curable adhesive, a two-component curable adhesive, a thermal fusion adhesive, and a pressure-sensitive adhesive (so-called tackiness agent).

Among the above, when an impact absorbing layer 5 is placed on the substrate layer 2, on an opposite surface side to the functional layer 3, and when the adhesive layer for adhesion 6 is placed on the impact absorbing layer 5, on an opposite surface side to the substrate layer 2, and the interlayer adhesive layer 7 described later is placed between the substrate layer 2 and the impact absorbing layer 5 as shown in FIG. 6, for example, the adhesive layer for adhesion and the interlayer adhesive layer preferably include the pressure-sensitive adhesive, that is, preferably pressure-sensitive adhesive layers. Generally, the pressure-sensitive adhesive layer is relatively a soft layer among the adhesive layers including the adhesives described above. The impact resistance may be improved by including the impact absorbing layer between the pressure-sensitive adhesive layers those are relatively soft. Since the pressure-sensitive adhesive layer is relatively soft so as to be easily deformed, the impact absorbing layer is easily deformed when an impact is applied to the stacked body for a display device because the deformation of the impact absorbing layer is not suppressed by the pressure-sensitive adhesive layer so that higher impact absorbing effect is believed to be exhibited.

Examples of the pressure-sensitive adhesive used for the pressure-sensitive adhesive layer may include an acrylic based pressure-sensitive adhesive, a silicone based pressure-sensitive adhesive, a rubber based pressure-sensitive adhesive, and a urethane based pressure-sensitive adhesive, and may be appropriately selected according to the material of the impact absorbing layer. Among them, an acrylic based pressure-sensitive adhesive is preferable. This is because, an acrylic based pressure-sensitive adhesive has excellent transparency, weather resistance, durability, and heat resistance, and is low cost.

The thickness of the adhesive layer for adhesion is preferably, for example, 10 μm or more and 100 μm or less, more preferably 25 μm or more and 80 μm or less, and further preferably 40 μm or more and 60 μm or less. When the thickness of the adhesive layer for adhesion is too thin, the stacked body for a display device and the display panel may not be adhered sufficiently. Also, when the adhesive layer for adhesion is a pressure-sensitive adhesive layer, if the thickness of the adhesive layer for adhesion is too thin, the effect of making the impact absorbing layer to be easily deformed, when an impact is imparted to the stacked body for a display device, may not be obtained sufficiently. Meanwhile, when the thickness of the adhesive layer for adhesion is too thick, the flexibility may be deteriorated.

As the adhesive layer for adhesion, for example, an adhesive film may be used. Also, for example, the adhesive layer for adhesion may be formed by coating a supporting body or the substrate layer, for example, with an adhesive composition.

### 7. Interlayer Adhesive Layer

In the stacked body for a display device in the present disclosure, an interlayer adhesive layer may be placed between each layer.

The adhesive used for the interlayer adhesive layer may be similar to the adhesive used for the adhesive layer for adhesion.

Among the above, as described above, when the impact absorbing layer is placed on the substrate layer, on the opposite surface side to the functional layer; the adhesive layer for adhesion is placed on the impact absorbing layer, on the opposite surface side to the substrate layer; and the interlayer adhesive layer is placed between the substrate layer and the impact absorbing layer, the adhesive layer for adhesion and the interlayer adhesive layer preferably include the pressure-sensitive adhesive, that is, they are preferably pressure-sensitive adhesive layers.

The pressure-sensitive adhesive layer may be similar to the pressure-sensitive adhesive layer used for the adhesive layer for adhesion.

The thickness of the interlayer adhesive layer, and the forming method, for example, may be similar to the thickness and the forming method, for example, of the adhesive layer for adhesion.

### 8. Others Regarding Stacked Body for Display Device

The thickness of the stacked body for a display device in the present disclosure is preferably, for example, 10 μm or more and 500 μm or less, more preferably 20 μm or more and 400 μm or less, and further preferably 30 μm or more and 300 μm or less. When the thickness of the stacked body for a display device is in the above range, the flexibility may be improved.

The stacked body for a display device in the present disclosure may be used as a front panel placed on the observer side than the display panel in a display device. Among the above, the stacked body for a display device in the present disclosure may be preferably used as a front panel in a flexible display device such as a foldable display, a rollable display, and a bendable display. Particularly, the stacked body for a display device in the present disclosure is suitably used for the front panel in a foldable display, since it improves the abrasion resistance in the bent portion.

Also, the stacked body for a display device in the present disclosure may be used as a front panel in a display device such as smart phones, tablet terminals, wearable terminals, personal computers, televisions, digital signages, public information displays (PIDs), and car mounted displays.

### B. Display Device

The display device in the present disclosure comprises: a display panel, and the stacked body for a display device described above placed on an observer side of the display panel.

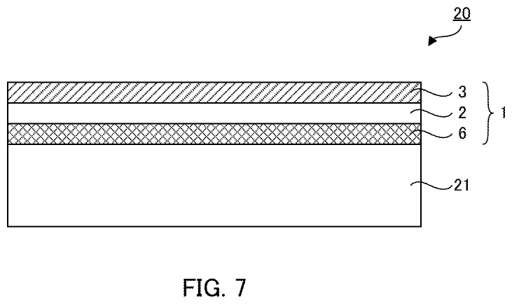

FIG. 7 is a schematic cross-sectional view illustrating an example of a display device in the present disclosure. As shown in FIG. 7, display device 20 comprises a display panel 21, and the stacked body for a display device 1 placed on an observer side of the display panel 21. In the display device 20, the stacked body for a display device 1 and the display panel 21 may be adhered via, for example, the adhesive layer for adhesion 6 of the stacked body for a display device 1.

When the stacked body for a display device in the present disclosure is placed on the surface of the display device, it is placed so that the functional layer is on the outer side, and the substrate layer is on the inner side.

The method for placing the stacked body for a display device in the present disclosure on the surface of the display device is not particularly limited, and examples thereof may include a method via an adhesive layer.

Examples of the display panel in the present disclosure may include a display panel used for a display device such as an organic EL display device, and a liquid crystal display device.

The display device in the present disclosure may include a touch-sensitive panel member between the display panel and the stacked body for a display device.

Among the above, the display device in the present disclosure is preferably a flexible display device such as a foldable display, a rollable display, and a bendable display.

Also, the display device in the present disclosure is preferably foldable. That is, the display device in the present disclosure is preferably a foldable display. The display device in the present disclosure has excellent abrasion resistance in the bent portion, so that it is suitable for a foldable display.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

The present disclosure is hereinafter explained in further details with reference to Examples and Comparative Examples.

### Example 1

### (1) Formation of Hard Coating Layer A

Firstly, a resin composition for a hard coating layer 1 was obtained by compounding each component so as to be the composition shown below.

### (Composition of Resin Composition for Hard Coating Layer 1)

Urethane acrylate (product name “8UX-141A” from Taisei Fine Chemicals Co., Ltd.): 100 parts by mass (solid content 100% conversion value)
Polymerization initiator (1-hydroxycyclohexylphenyl ketone, product name “Omnirad184” from IGM Resins B. V.): 4 parts by mass
Leveling agent (product name “BYK-UV3535” from BYK-Chemie Japan Co., Ltd.): 0.5 parts by mass (solid content 100% conversion value)
Methyl isobutyl ketone: 250 parts by mass

Then, using a polyimide film (product name “Neopulim” from Mitsubishi Gas Chemical Company, Inc.) having a thickness of 80 μm as a substrate layer, a coating film was formed on the substrate layer by applying the resin composition for a hard coating layer 1 with a bar coater. Thereafter, the coating film was heated at 80° C. for 1 minute to evaporate the solvent in the coating film, and the coating film was cured by irradiating ultraviolet rays with an ultraviolet ray irradiation device (light source H bulb from Fusion UV Systems Japan K.K) under the condition of an oxygen concentration of 100 ppm or less so that the integrated light amount was 70 mJ/cm² to form a hard coating layer A with a thickness of 9.0 μm, as a second functional layer.

### (2) Formation of Hard Coating Layer B

Firstly, a resin composition for a hard coating layer 2 was obtained by compounding each component so as to be the composition shown below.

### (Composition of Resin Composition for Hard Coating Layer 2)

Urethane acrylate (product name “8UX-015A” from Taisei Fine Chemicals Co., Ltd.): 100 parts by mass (solid content 100% conversion value)
Polymerization initiator (1-hydroxycyclohexylphenyl ketone, product name “Omnirad184” from IGM Resins B. V.): 4 parts by mass
Antifoulant (product name “DAC-HP” Daikin Industries, Ltd.): 0.5 parts by mass (solid content 100% conversion value)
Antistatic agent (product name “Beamset MT-2” from Arakawa Chemical Industries, Ltd.): 1.5 parts by mass (solid content 100% conversion value)
Methyl isobutyl ketone: 250 parts by mass

Then, a coating film was formed on the hard coating layer A by applying the resin composition for a hard coating layer 2 with a bar coater. Thereafter, the coating film was heated at 50° C. for 1 minute to evaporate the solvent in the coating film, and the coating film was cured by irradiating ultraviolet rays with an ultraviolet ray irradiation device (light source H bulb from Fusion UV Systems Japan K.K) under the condition of an oxygen concentration of 100 ppm or less so that the integrated light amount was 360 mJ/cm² to form a hard coating layer B with a thickness of 3.0 μm, as a functional layer. As described above, a stacked body including a substrate layer, a hard coating layer A (second functional layer) and a hard coating layer B (functional layer) in this order was obtained.

### Comparative Example 1

A stacked body was produced in the same manner as in Example 1 except that, in the formation of the hard coating layer B (functional layer), the following resin composition for a hard coating layer 3 was used.

### (Composition of Resin Composition for Hard Coating Layer 3)

Urethane acrylate (product name “8UX-141A” from Taisei Fine Chemicals Co., Ltd.): 100 parts by mass (solid content 100% conversion value)
Polymerization initiator (1-hydroxycyclohexylphenyl ketone, product name “Omnirad184” from IGM Resins B. V.): 4 parts by mass
Antifoulant (product name “DAC-HP” Daikin Industries, Ltd.): 0.5 parts by mass (solid content 100% conversion value)
Methyl isobutyl ketone: 250 parts by mass

### Example 2

A stacked body was produced in the same manner as in Example 1 except that, as the substrate layer, a PET film (“Cosmoshine A4160” from Toyobo Co., Ltd.) with a thickness of 50 μm was used.

### Example 3

A stacked body was produced in the same manner as in Example 2 except that, in the formation of the hard coating layer B (functional layer), the following resin composition for a hard coating layer 4 was used, and the thickness thereof was 4.0 μm.

### (Composition of Resin Composition for Hard Coating Layer 4)

Urethane acrylate (product name “8UX-141A” from Taisei Fine Chemicals Co., Ltd.): 100 parts by mass (solid content 100% conversion value)
Polymerization initiator (1-hydroxycyclohexylphenyl ketone, product name “Omnirad184” from IGM Resins B. V.): 4 parts by mass
Antifoulant (product name “DAC-HP” Daikin Industries, Ltd.): 0.5 parts by mass (solid content 100% conversion value)
Antistatic agent (product name “Beamset MT-2” from Arakawa Chemical Industries, Ltd.): 2 parts by mass (solid content 100% conversion value)
Methyl isobutyl ketone: 250 parts by mass

### Example 4

A stacked body was produced in the same manner as in Example 2 except that the hard coating layer A (second functional layer) was not formed, and, in the formation of the hard coating layer B (functional layer), the resin composition for a hard coating layer 4 described above was used, and the thickness thereof was 3.5 μm.

### Example 5

A stacked body was produced in the same manner as in Example 3 except that, in the formation of the hard coating layer B (functional layer), the thickness thereof was 3.3 μm.

### Example 6

A stacked body was produced in the same manner as in Example 3 except that, in the formation of the hard coating layer B (functional layer), the thickness thereof was 3.8 μm.

### Example 7

A stacked body was produced in the same manner as in Example 3 except that, in the formation of the hard coating layer B (functional layer), the following resin composition for a hard coating layer 5 was used, and the thickness thereof was 3.5 μm.

### (Composition of Resin Composition for Hard Coating Layer 5)

Urethane acrylate (product name “8UX-141A” from Taisei Fine Chemicals Co., Ltd.): 50 parts by mass (solid content 100% conversion value)
Urethane acrylate (product name “8UX-015A” from Taisei Fine Chemicals Co., Ltd.): 50 parts by mass (solid content 100% conversion value)
Polymerization initiator (1-hydroxycyclohexylphenyl ketone, product name “Omnirad184” from IGM Resins B. V.): 4 parts by mass
Antifoulant (product name “DAC-HP” Daikin Industries, Ltd.): 0.5 parts by mass (solid content 100% conversion value)
Antistatic agent (product name “Beamset MT-2” from Arakawa Chemical Industries, Ltd.): 2 parts by mass (solid content 100% conversion value)
Methyl isobutyl ketone: 250 parts by mass

### Example 8

A stacked body was produced in the same manner as in Example 2 except that the resin composition for a hard coating layer 6 including an antistatic agent was used for the second functional layer.

### (Composition of Resin Composition for Hard Coating Layer 6)

Urethane acrylate (product name “8UX-141A” from Taisei Fine Chemicals Co., Ltd.): 100 parts by mass (solid content 100% conversion value)
Polymerization initiator (1-hydroxycyclohexylphenyl ketone, product name “Omnirad184” from IGM Resins B. V.): 4 parts by mass
Leveling agent (product name “BYK-UV3535” from BYK-Chemie Japan Co., Ltd.): 0.5 parts by mass (solid content 100% conversion value)
Antistatic agent (product name “Beamset MT-2” from Arakawa Chemical Industries, Ltd.): 2.5 parts by mass (solid content 100% conversion value)
Methyl isobutyl ketone: 250 parts by mass

### Example 9

A stacked body was produced in the same manner as in Example 8 except that the resin composition for a hard coating layer 7 not including an antistatic agent was used for the functional layer.

### (Composition of Resin Composition for Hard Coating Layer 7)

Urethane acrylate (product name “8UX-015A” from Taisei Fine Chemicals Co., Ltd.): 100 parts by mass (solid content 100% conversion value)
Polymerization initiator (1-hydroxycyclohexylphenyl ketone, product name “Omnirad184” from IGM Resins B. V.): 4 parts by mass
Antifoulant (product name “DAC-HP” Daikin Industries, Ltd.): 0.5 parts by mass (solid content 100% conversion value)
Methyl isobutyl ketone: 250 parts by mass

### Example 10

A stacked body was produced in the same manner as in Example 9 except that, the thickness of the functional layer was 5.8 μm.

### Example 11

A stacked body was produced in the same manner as in Example 9 except that, the thickness of the functional layer was 9.4 μm.

### Example 12

Firstly, a coating film was formed on the hard coating layer A (second functional layer) in Example 2 by applying the resin composition for a hard coating layer 8 with a bar coater. Thereafter, the coating film was heated at 80° C. for 1 minute to evaporate the solvent in the coating film, and the coating film was cured by irradiating ultraviolet rays with an ultraviolet ray irradiation device (light source H bulb from Fusion UV Systems Japan K.K) under the condition of an oxygen concentration of 100 ppm or less so that the integrated light amount was 70 mJ/cm² to form a hard coating layer B (functional layer) with a thickness of 3.0 μm, as a functional layer.

### (Composition of Resin Composition for Hard Coating Layer 8)

Urethane acrylate (product name “8UX-015A” from Taisei Fine Chemicals Co., Ltd.): 100 parts by mass (solid content 100% conversion value)
Polymerization initiator (1-hydroxycyclohexylphenyl ketone, product name “Omnirad184” from IGM Resins B. V.): 4 parts by mass
Leveling agent (product name “BYK-UV3535” from BYK-Chemie Japan Co., Ltd.): 0.5 parts by mass (solid content 100% conversion value)
Antistatic agent (product name “Beamset MT-2” from Arakawa Chemical Industries, Ltd.): 1.5 parts by mass (solid content 100% conversion value)
Methyl isobutyl ketone: 250 parts by mass

Then, using a composition for an antireflection layer (low refractive index) having the following composition, an antireflection layer (low refractive index) with a thickness of 100 nm was produced on the hard coating layer B (functional layer) under the following processing conditions to obtain a stacked body.

### (Composition of Composition for Antireflection Layer (Low Refractive Index))

Polymerization initiator (1-hydroxycyclohexylphenyl ketone, product name “Omnirad184” from IGM Resins B. V.): 3 parts by mass
Urethane acrylate (product name “8UX-047A” from Taisei Fine Chemicals Co., Ltd.): 25 parts by mass
Polyfunctional acrylate (product name “M-510”, from Toagosei Co., Ltd.): 45 parts by mass
Pentaerythritol tri and tetra acrylate (product name “M-450”, from Toagosei Co., Ltd.): 30 parts by mass
Low refractive index particles (hollow silica, average primary particle size: 50 nm, from JGC Catalysts and Chemicals): 120 parts by mass (solid content 100% conversion value)
Low refractive index particles (silica, average primary particle size: 12 nm, from Nissan Chemical Corporation): 15 parts by mass (solid content 100% conversion value)
Methyl isobutyl ketone: 270 parts by mass
Isopropyl alcohol: 40 parts by mass

### (Processing Conditions)

After heating at 90° C. for one minute, ultraviolet rays were irradiated under the condition of an oxygen concentration of 100 ppm or less so that the integrated light amount was 500 mJ/cm².

### Example 13

Using a composition for an antireflection layer (high refractive index) having the following composition, an antireflection layer (high refractive index) with a thickness of 80 nm was produced on the hard coating layer B (functional layer) described in Example 12, under the following processing conditions. Then, an antireflection layer (low refractive index) similar to the one produced in Example 12 was produce to obtain a stacked body.

### (Composition of Composition for Antireflection Layer (High Refractive Index))

Polymerization initiator (1-hydroxycyclohexylphenyl ketone, product name “Omnirad184” from IGM Resins B. V.): 3 parts by mass
Pentaerythritol (tri/tetra) acrylate (product name “PETIA”, from Daicel-Allnex Ltd.): 80 parts by mass
Polyfunctional acrylate (product name “M-510”, from Toagosei Co., Ltd.): 20 parts by mass
High refractive index particles (zirconia, average primary particle size 20 nm, from CIK Nano Tek Corporation): 120 parts by mass (solid content 100% conversion value)
Methyl isobutyl ketone: 270 parts by mass
Isopropyl alcohol: 40 parts by mass

### (Processing Conditions)

After heating at 70° C. for one minute, ultraviolet rays were irradiated under the condition of an oxygen concentration of 100 ppm or less so that the integrated light amount was 60 mJ/cm².

### Example 14

A stacked body was obtained in the same manner as in Example 13 except that, the thickness of the antireflection layer (high refractive index) was 190 nm.

### Comparative Example 2

A stacked body was produced in the same manner as in Example 4 except that, in the formation of the hard coating layer B (functional layer), the thickness thereof was 3.0 μm.

### Comparative Example 3

A stacked body was produced in the same manner as in Example 3 except that, in the formation of the hard coating layer B (functional layer), the thickness thereof was 2.5 μm.

### Comparative Example 4

A stacked body was produced in the same manner as in Example 3 except that, in the formation of the hard coating layer B (functional layer), the following resin composition for a hard coating layer 9 was used, and the thickness thereof was 2.5 μm.

### (Composition of Resin Composition for Hard Coating Layer 9)

Urethane acrylate (product name “8UX-141A” from Taisei Fine Chemicals Co., Ltd.): 100 parts by mass (solid content 100% conversion value)
Polymerization initiator (1-hydroxycyclohexylphenyl ketone, product name “Omnirad184” from IGM Resins B. V.): 4 parts by mass
Antifoulant (product name “DAC-HP” Daikin Industries, Ltd.): 0.5 parts by mass (solid content 100% conversion value)
Antistatic agent (product name “Beamset MT-2” from Arakawa Chemical Industries, Ltd.): 10 parts by mass (solid content 100% conversion value)
Methyl isobutyl ketone: 250 parts by mass

### Comparative Example 5

A stacked body was produced in the same manner as in Example 9 except that, the thickness of the functional layer was 10.3 μm.

### [Evaluation]

(1) Charge Amount after Eraser Test

The following eraser test was carried out on the functional layer side surface of the stacked body in Examples and Comparative Examples, and the charge amount on the functional layer side surface of the stacked body after the eraser test was measured.

Firstly, the ionizer was applied to a glass plate, which is a test stand, for one minute at 23±5° C. and 40±10% RH to eliminate static. Also, a stacked body with a size of 20 mm×80 mm was prepared, and the ionizer was applied to both surfaces of the stacked body for 30 seconds or more and 60 seconds or less at 23±5° C. and 40±10% RH to eliminate static.

Then, the end portion of the stacked body was fixed on the glass plate with cellophane tape, and an eraser test was carried out on the functional layer side surface of the stacked body. Specifically, using a 6 mm diameter eraser from Minoan Co., Ltd., the eraser was inserted into a jig provided with a 6 mm diameter hole so that 4 mm of the tip of the eraser was exposed from the jig, the jig with the eraser was installed into a color fastness rubbing tester (product name “AB-301” from Tester Sangyo Co., Ltd.), and the functional layer side surface of the stacked body was rubbed for 2500 strokes, with the eraser, at temperature of 23±5° C., humidity of 40±10% RH, load of 9.8 N, traveling speed of 80 mm/sec, and traveling distance of 40 mm.

Then, the stacked body after the eraser test was set on the Faraday gauge and the charge amount was measured. In doing so, insulating and non-magnetic tweezers were used to lift the stacked body after the eraser test. Also, after lifting the stacked body after the eraser test, the charge amount was measured without contacting to other fixed surfaces. As the Faraday gauge, a Faraday gauge “KQ-1400” from Kasuga Denki Inc. was used. Also, “KD-750B” fan-type ionizer from Kasuga Denki Inc. was used as the ionizer. Also, ESD (electrostatic countermeasure) tweezers “P-643-S” from Kenis Limited were used as tweezers.

### (2) Frictional Force Before and After Eraser Test

The eraser test described above was carried out on the functional layer side surface of the stacked body in Examples and Comparative Examples, and the frictional force to the eraser was measured on the functional layer side surface of the stacked body before and after the eraser test.

In the measurement of the frictional force to the eraser, the frictional force was measured by using a 6 mm diameter eraser from Minoan Co., Ltd., the eraser was inserted into a jig provided with a 6 mm diameter hole so that 4 mm of the tip of the eraser was exposed from the jig, the jig with the eraser was installed into a continuous loading scratching intensity tester (product name “TriboGear Type 18” from Shinto Scientific Co., Ltd.), and the functional layer side surface of the stacked body was rubbed with the eraser, at temperature of 23±5° C., humidity of 40±10% RH, load of 1.96 N and traveling speed of 840 mm/min, in the order of eraser test-untested portion, eraser tested portion, and eraser test-untested portion. In doing so, as shown with an arrow in FIG. 2, the eraser was moved vertically to the longitudinal direction of the rectangle eraser tested portion 32.

For the frictional force to the eraser at the eraser tested portion, the maximum value of the frictional force was determined. Also, for the frictional force to the eraser at the eraser test-untested portion, the average value of the friction force at the eraser test-untested portion 31, when the point at which the frictional force to the eraser at the eraser tested portion 32 was the maximum was regarded as 0 mm, was determined in a range of 4.2 mm or more and 9.8 mm or less, on the basis of the point (0 mm) described above, as shown in FIG. 2.

Also, the ratio of the frictional force before and after the eraser test was calculated from the following formula, on the functional layer side surface of the stacked body, when the average value of the frictional force at the eraser test-untested portion was regarded as “A”; and the maximum value of a frictional force at the eraser tested portion was regarded as “B”.

Ratio of frictional force=B/A

### (3) Sliding Property Before and After Eraser Test

The eraser test described above was carried out on the functional layer side surface of the stacked body in Examples and Comparative Examples, and the sliding property on the functional layer side surface of the stacked body before and after the eraser test was evaluated.

Specifically, the functional layer side surface of the stacked body was rubbed with a fingertip at temperature of 23±5° C., humidity of 40±10% RH and traveling speed of 10 cm/sec, in the order of eraser test-untested portion, eraser tested portion, and eraser test-untested portion. The sliding property at the eraser tested portion at that time was evaluated based on the following criteria.
A: 7 or more out of 10 people did not feel scratchy
B: 5 or 6 out of 10 people did not feel scratchy
C: 6 or 7 out of 10 people felt scratchy
D: 8 or more out of 10 people felt scratchy

### (4) Steel Wool Test

Firstly, a protection film including an adhesive layer on one surface of a PET substrate (thickness of PET substrate: 100 μm or more and 125 μm or less, thickness of adhesive layer: 10 μm or more and 25 μm or less) was adhered to the substrate layer side surface of the stacked body with a size of 4 cm×10 cm, and then, the end portion of the stacked body was fixed with cellophane tape on the test stand of Color Fastness Rubbing Tester AB-301 from Tester Sangyo Co., Ltd. Then, using #0000 steel wool (Bonstar #0000 from Nippon Steel Wool Co., Ltd.), the steel wool was fixed to a 2 cm×2 cm jig, the functional layer side surface of the stacked body for a display device was rubbed for 2500 strokes under conditions of load of 9.8 N, reciprocating speed of 40 rpm, reciprocating distance of 40 mm and steel wool installation area of 4 cm², at temperature of 23±5° C. and humidity of 40±10% RH. The presence or absence of a scratch was confirmed by transmission and reflection.

TABLE 1

| | | | | | | | | Avg. | | | | |
|---|---|---|---|---|---|---|---|---|---|---|---|---|
| | | | | | | | | frictional | Max. | | | |
| | | | | | | | | force (N) | frictional | | | |
| | | | 2nd | Functional layer | | | | Pre- | force (N) | | | |
| | Substrate layer | | func. ly. | | | Antistatic | | eraser test | Post- | | Eraser | |
| | | Thick- | Thick- | Thick- | | agent amt. | Charge | (eraser test | eraser test | Ratio of | test | |
| | | ness | ness | ness | Resin | (pt by | amount | untested | (eraser tested | frictional | sliding | |
| | Material | (μm) | (μm) | (μm) | comp. | mass) | (nC) | portion) | portion) | force | prop. | SW test |
| Comp. Ex. 1 | Polyimide | 80 | 9.0 | 3.0 | I | 0 | −11.91 | 4.84 | 8.71 | 1.80 | D | No scratch |
| Example 1 | Polyimide | 80 | 9.0 | 3.0 | II | 1.5 | −0.70 | 4.12 | 5.40 | 1.31 | A | No scratch |
| Example 2 | PET | 50 | 9.0 | 3.0 | II | 1.5 | −0.81 | 3.64 | 5.17 | 1.42 | A | No scratch |
| Example 3 | PET | 50 | 9.0 | 4.0 | I | 2 | −2.10 | 3.94 | 5.32 | 1.35 | A | No scratch |
| Example 4 | PET | 50 | — | 3.5 | I | 2 | −8.65 | 4.03 | 6.09 | 1.51 | B | No scratch |
| Example 5 | PET | 50 | 9.0 | 3.3 | I | 2 | −9.46 | 4.30 | 7.12 | 1.66 | C | No scratch |
| Example 6 | PET | 50 | 9.0 | 3.8 | I | 2 | −7.82 | 3.68 | 5.45 | 1.48 | B | No scratch |
| Example 7 | PET | 50 | 9.0 | 3.5 | I + II | 2 | −5.35 | 4.10 | 5.94 | 1.45 | B | No scratch |
| Example 8 | PET | 50 | 9.0 | 3.0 | II | 1.5 | −0.67 | 3.76 | 4.85 | 1.29 | A | No scratch |
| Example 9 | PET | 50 | 9.0 | 3.0 | II | 0 | −2.89 | 4.03 | 5.96 | 1.48 | B | No scratch |
| Example 10 | PET | 50 | 9.0 | 5.8 | II | 0 | −6.77 | 4.09 | 6.42 | 1.57 | B | No scratch |
| Example 11 | PET | 50 | 9.0 | 9.4 | II | 0 | −9.78 | 4.41 | 7.40 | 1.68 | C | No scratch |
| Example 12 | PET | 50 | 9.0 | 3.0 | II | 1.5 | −0.93 | 3.81 | 5.60 | 1.47 | A | No scratch |
| Example 13 | PET | 50 | 9.0 | 3.0 | II | 1.5 | −0.97 | 3.89 | 5.83 | 1.50 | A | No scratch |
| Example 14 | PET | 50 | 9.0 | 3.0 | II | 1.5 | −1.22 | 3.87 | 5.88 | 1.52 | A | No scratch |
| Comp. Ex. 2 | PET | 50 | — | 3.0 | I | 2 | −10.40 | 4.65 | 8.14 | 1.75 | D | No scratch |
| Comp. Ex. 3 | PET | 50 | 9.0 | 2.5 | I | 2 | −16.17 | 5.05 | 9.39 | 1.86 | D | No scratch |
| Comp. Ex. 4 | PET | 50 | 9.0 | 2.5 | I | 10 | −23.10 | 4.21 | 9.83 | 2.33 | D | With scratch |
| Comp. Ex. 5 | PET | 50 | 9.0 | 10.3 | II | 0 | −13.23 | 4.67 | 8.35 | 1.79 | D | No scratch |

(5) Proportion of Number of Fluorine Atoms with Respect to Total Number of Atoms of all Elements Before and After the Eraser Test

The eraser test described above was carried out on the functional layer side surface of the stacked body in Example 1 and Comparative Example 1, and a composition analysis was carried out, by an X-ray photoelectron spectroscopy method (XPS), on the functional layer side surface of the stacked body before and after the eraser test, and on the eraser surface before and after the eraser test. Firstly, using an X-ray photoelectron spectrometer (AXIS-NOVA from Kratos Analytical Ltd.), X-rays were irradiated from the sample surface in the depth direction under the following conditions, and X-ray photoelectron spectrum was measured by setting C, O, F, N, Si, Ca and Cl as analysis target elements.

From the resulting spectrum, the background determined by the Shirley method was deducted, and the proportion of the number of atoms of each element with respect to the total number of atoms of all elements on the sample surface (ratio of the number of atoms (at %) of each atom when total number of atoms of carbon atoms, oxygen atoms, fluorine atoms, nitrogen atoms, silicon atoms, calcium atoms, and chlorine atoms was regarded as 100 at %) was determined from the peak area using a relative sensitivity coefficient method. The results are shown in Table 2 and Table 3.

### (Measurement Conditions)

Incident X-ray: Monochromated Al-Kα-ray (monochromated X-ray, Hv=1486.6 eV)
X-ray irradiation region (measured area): 110 μm
X-ray output: 150 W (15 kV·6.7 mA)
Photoelectron intake angle: 90°±150 (sample normal line was regarded as 0°)
Charge neutralization conditions: electron neutralization gun (+6 V, 0.05 mA), low-acceleration Ar⁺ ion irradiation
Measured peaks: C1s, O1s, F1s, N1s, Si2p, Ca2p, Cl2p

TABLE 2

| Example 1 | | C 1s | O 1s | F 1s | N 1s | Si 2p | Ca 2p | Cl 2p |
|---|---|---|---|---|---|---|---|---|
| Functional | Before eraser test | 48.26 | 20.56 | 28.50 | 1.73 | 0.95 | — | — |
| layer side | (eraser test untested portion) | | | | | | | |
| surface of | After eraser test | 52.18 | 21.32 | 23.29 | 2.25 | 0.96 | — | — |
| stacked body | (eraser tested portion) | | | | | | | |
| Eraser surface | Before eraser test | 69.82 | 19.68 | — | — | — | 3.87 | 6.63 |
| | After eraser test | 67.81 | 20.15 | 2.34 | — | — | 4.21 | 5.49 |

TABLE 3

| Comparative Example 1 | | C 1s | O 1s | F 1s | N 1s | Si 2p | Ca 2p | Cl 2p |
|---|---|---|---|---|---|---|---|---|
| Functional | Before eraser test | 47.10 | 19.47 | 30.94 | 1.62 | 0.87 | — | — |
| layer side | (eraser test untested portion) | | | | | | | |
| surface of | After eraser test | 63.03 | 25.17 | 8.33 | 2.59 | 0.88 | — | — |
| stacked body | (eraser tested portion) | | | | | | | |
| Eraser surface | Before eraser test | 69.52 | 19.81 | — | — | — | 4.02 | 6.65 |
| | After eraser test | 55.37 | 20.75 | 14.28 | — | — | 4.76 | 4.84 |

From Tables 2 to 3, since the proportion of number of fluorine atoms with respect to a total number of atoms of all elements on the functional layer side surface of the stacked body decreased after the eraser test, and the proportion of number of fluorine atoms with respect to a total number of atoms of all elements on the eraser surface increased, it was confirmed that fluorine atoms included in the functional layer were adhered to the eraser by rubbing the functional layer side surface of the stacked body with the eraser. This is believed that the surface of the functional layer was negatively charged by rubbing the functional layer side surface of the stacked body with an eraser; the contact surface of the eraser was positively charged due to thereof; as the result, the static electricity force was increased and the gravitational force was increase; the highly negative fluorine desorbed from the surface of the functional layer; and adhered to the surface of the eraser.

Also, from Table 1, it was confirmed that, when the absolute value of a charge amount on the functional layer side surface of the stacked body after the eraser test was in a predetermined range, the variation of sliding property before and after the eraser test was low, and abrasion resistance was high. This is believed that, since the absolute value of a charge amount on the functional layer side surface of the stacked body after the eraser test was in a predetermined range, the desorption of fluorine from the surface of the functional layer may be suppressed, and as the result, good abrasion resistance may be obtained.

In other words, in the present disclosure, the following inventions may be provided.

[1]

A stacked body for a display device comprising a substrate layer and a functional layer including fluorine, wherein an absolute value of a charge amount on a functional layer side surface of the stacked body for a display device after an eraser test is 10.0 nC or less, wherein, in the eraser test, the functional layer side surface of the stacked body for a display device is rubbed with a 6 mm diameter eraser, for 2500 strokes, applying a load of 9.8 N.

[2]

The stacked body for a display device according to [1], wherein a ratio of a maximum value of a frictional force to the eraser after the eraser test with respect to an average value of a frictional force to the eraser before the eraser test, on the functional layer side surface of the stacked body for a display device before the eraser test, is 1.7 or less.

[3]

The stacked body for a display device according to [1] or [2], wherein a ratio of a proportion of number of fluorine atoms with respect to a total number of atoms of all elements on the functional layer side surface after the eraser test; with respect to a proportion of number of fluorine atoms with respect to a total number of atoms of all elements on the functional layer side surface before the eraser test, measured by an X-ray photoelectron spectroscopy method, is 0.4 or more.

[4]

The stacked body for a display device according to any one of [1] to [3], wherein the functional layer includes an antistatic agent.

[5]

The stacked body for a display device according to [4], wherein the antistatic agent is a conductive polymer.

[6]

The stacked body for a display device body according to any one of [1] to [5], wherein an impact absorbing layer is included on the substrate layer, on an opposite surface side to the functional layer, or between the substrate layer and the functional layer.

[7]

The stacked body for a display device according to any one of [1] to [6], wherein an adhesive layer for adhesion is included on the substrate layer, on an opposite surface side to the functional layer.

[8]

The stacked body for a display device according to any one of [1] to [7], wherein a distance between a functional layer side outermost surface of the stacked body for a display device and a layer including an antistatic agent is 10 μm or less.

[9]

The stacked body for a display device according to any one of [1] to [8], wherein an antireflection layer is placed on a functional layer side outermost surface of the stacked body for a display device.

[10]

A display device comprising: a display panel, and the stacked body for a display device according to any one of [1] to [9] placed on an observer side of the display panel.

### REFERENCE SIGNS LIST

1: stacked body for a display device
2: substrate layer
3: functional layer
4: hard coating layer
5: impact absorbing layer
6: adhesive layer for adhesion
7: interlayer adhesive layer
20: flexible display device
21: display panel

1. A stacked body for a display device comprising a substrate layer and a functional layer including fluorine,
wherein an absolute value of a charge amount on a functional layer side surface of the stacked body for a display device after an eraser test is 10.0 nC or less, wherein, in the eraser test, the functional layer side surface of the stacked body for a display device is rubbed with a 6 mm diameter eraser, for 2500 strokes, applying a load of 9.8 N.

2. The stacked body for a display device according to claim 1, wherein a ratio of a maximum value of a frictional force to the eraser after the eraser test with respect to an average value of a frictional force to the eraser before the eraser test, on the functional layer side surface of the stacked body for a display device before the eraser test, is 1.7 or less.

3. The stacked body for a display device according to claim 1, wherein a ratio of a proportion of number of fluorine atoms with respect to a total number of atoms of all elements on the functional layer side surface after the eraser test; with respect to a proportion of number of fluorine atoms with respect to a total number of atoms of all elements on the functional layer side surface before the eraser test, measured by an X-ray photoelectron spectroscopy method, is 0.4 or more.

4. The stacked body for a display device according to claim 1, wherein the functional layer includes an antistatic agent.

5. The stacked body for a display device according to claim 4, wherein the antistatic agent is a conductive polymer.

6. The stacked body for a display device according to claim 1, wherein an impact absorbing layer is included on the substrate layer, on an opposite surface side to the functional layer, or between the substrate layer and the functional layer.

7. The stacked body for a display device according to claim 1, wherein an adhesive layer for adhesion is included on the substrate layer, on an opposite surface side to the functional layer.

8. The stacked body for a display device according to claim 1, wherein a distance between a functional layer side outermost surface of the stacked body for a display device and a layer including an antistatic agent is 10 μm or less.

9. The stacked body for a display device according to claim 1, wherein an antireflection layer is placed on a functional layer side outermost surface of the stacked body for a display device.

10. A display device comprising:
a display panel, and
the stacked body for a display device according to claim 1 placed on an observer side of the display panel.
